(19) United States
(12) Patent Application Publication
(10) Pub. No.: US 2024/0346398 A1
(43) Pub. Date: Oct. 17, 2024

(54) Artificial Intelligence Systems and Methods

(71) Applicant: RYLTI, LLC, Hauppauge, NY (US)

(72) Inventors: Peter J. FIORILLO, Hauppauge, NY (US); Joseph GLICK, Hauppauge, NY (US)

(21) Appl. No.: 18/751,007

(22) Filed: Jun. 21, 2024

Related U.S. Application Data
(63) Continuation-in-part of application No. 18/305,969, filed on Apr. 24, 2023.
(63) Continuation-in-part of application No. 16/555,611, filed on Aug. 29, 2019.
(63) Continuation of application No. 16/600,376, filed on Oct. 11, 2019.
(60) Provisional application No. 63/511,465, filed on Jun. 30, 2023.
(60) Provisional application No. 63/334,527, filed on Apr. 25, 2022.
(60) Provisional application No. 62/769,024, filed on Nov. 19, 2018.
(60) Provisional application No. 62/829,151, filed on Apr. 4, 2019.

(51) Int. Cl. G06Q 10/0631; G06F 9/451; G06N 3/08; G06Q 10/00; G06Q 50/00; G06Q 50/18

(52) U.S. Cl. CPC G06Q 10/0631; G06F 9/451; G06N 3/08; G06Q 10/00; G06Q 50/00; G06Q 50/18; G06Q 2220/00; G06Q 2220/12; G06Q 2220/18

(57) ABSTRACT

An artificial intelligence implemented method for executing a function by dynamically redefining a domain of the function to include dark data stored in a database. Discrete values are determined from among relevant values of relevant data events. Values that correspond to the discrete values are identified in other data events that are not relevant data events. Each discrete value is linked to each category in which the associated value for any data event corresponds to the discrete value, so as to identify one or more dark categories as categories that are linked to one or more of the discrete values and are not relevant categories. Each dark category is mapped to the function so as to redefine the domain. Data events are instantiated in the in-memory neural network according to the redefined domain. The function is executed in accordance with the redefined domain.

### CROSS-REFERENCE TO RELATED APPLICATIONS

This application claims the benefit of U.S. Provisional Application No. 63/511,465, filed on Jun. 30, 2023, the entire disclosure of which is expressly incorporated by reference herein.

This application is a continuation-in-part of U.S. application Ser. No. 18/305,969, filed on Apr. 24, 2023, which claims the benefit of U.S. Provisional Application No. 63/334,527, filed on Apr. 25, 2022, the entire disclosures of which are expressly incorporated by reference herein.

This application is a continuation-in-part of U.S. application Ser. No. 16/555,611, filed on Aug. 29, 2019, which claims the benefit of U.S. Provisional Application No. 62/769,024, filed on Nov. 19, 2018, the entire disclosures of which are expressly incorporated by reference herein.

This application is a continuation-in-part of U.S. application Ser. No. 16/600,376, filed on Oct. 11, 2019, which claims the benefit of U.S. Provisional Application No. 62/829,151, filed on Apr. 4, 2019, the entire disclosures of which are expressly incorporated by reference herein.

### BACKGROUND

The disclosed invention relates to improvements in artificial intelligence systems.

It is known that artificial intelligence systems are utilized for analysis functions, including big-data analysis functions. However, researchers typically must train artificial neural networks on hundreds to thousands of examples of a specific pattern or concept before the artificial synapse strengths adjust enough for the neural network to have “learned” that pattern or concept. Such systems are not currently able to carry their experiences from one set of circumstances to another-leading to the necessity of training new models for pattern recognizing new scenarios, even if those new scenarios are similar to those recognized via prior models. Such systems are indeed incapable of identifying new scenarios at all, without human intervention and substantial retraining.

There is also an increasing lag between the ability to generate big-data and to analyze it. This lag is further increased by the necessity of human retraining of the artificial intelligence models used in such analysis. Moreover, that retraining requires first that humans recognize the need for training new models. In other words, humans must first recognize that the current A.I. models are not recognizing a new pattern corresponding to a new scenario, before a new model can be trained to recognize it. It is for at least this reason that true causality determination—i.e., the ability to identify new scenarios that may correspond to an existing model—has evaded the field of artificial intelligence.

Further compounding difficulties is that the analysis of data sets is made more expensive and time consuming by the phenomenon that the incoming data is often provided from various sources and is therefore inconsistent. Moreover, such data sets are often limited in their usefulness by the phenomenon of dark data. Dark data is data that is present, but is not used by the artificial intelligence in executing the function-because the data is not within the domain of the function. Thus, the dark data is data that is “not seen” by the artificial intelligence in executing the function.

Moreover, even in non-big data set analytics, particularly for certain problem types (e.g., analysis of rare disease data to determine, for example, causation, treatment, etc.), there may be insufficient data available to train traditional A.I. models, or the problem type may require analysis of data from diverse data sources leading to the required analysis of multi-diverse and multi-scale data that traditional A.I. models are not capable of processing due to the requisite parallel processing of many-to-many relationships (which the traditional A.I. models cannot do).

It is an object of the invention to provide improved systems and methods for the execution of analytical functions by an artificial intelligence. Other objects, advantages and novel features will become apparent from the following detailed description of one or more embodiments.

### BRIEF DESCRIPTION OF THE DRAWINGS

FIG. 1 schematically illustrates an exemplary system in accordance with at least one embodiment;

FIG. 2 schematically illustrates an exemplary system architecture of the computing system in accordance with at least one embodiment;

FIG. 3 schematically illustrates an exemplary table for organizing data-events according to their defining data-event values for corresponding categories in accordance with at least one embodiment;

FIG. 4 schematically illustrates an exemplary linkset in accordance with at least one embodiment;

FIG. 5 schematically illustrates an exemplary ontological model in accordance with at least one embodiment;

FIG. 6 schematically illustrates an exemplary system platform architecture in accordance with at least one embodiment;

FIG. 7 schematically illustrates exemplary tailored linkset in accordance with at least one embodiment;

FIG. 8 schematically illustrates exemplary mapping so as to generate an index class in accordance with at least one embodiment;

FIG. 9 schematically illustrates exemplary generation of a detail class in accordance with at least one embodiment;

FIG. 10 schematically illustrates exemplary generation of a computed class in accordance with at least one embodiment;

FIG. 11 schematically illustrates exemplary multi-level data-event scenarios in accordance with at least one embodiment;

FIGS. 12A-C schematically illustrate aspects of identifying one or more discrete values in accordance with at least one embodiment;

FIG. 13 schematically illustrates aspects of identifying dark data values and dark data-events in accordance with at least one embodiment;

FIGS. 14A-B schematically illustrate aspects of identifying dark data categories and dark data sets in accordance with at least one embodiment;

FIG. 14C schematically illustrates an adjusted linkset for including dark data in accordance with at least one embodiment.

### DETAILED DESCRIPTION

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of entity resolution having the benefit of this disclosure.

As used herein, the term “computer system” can refer to a single programmable device or a plurality of programmable devices working together to perform the function described as being performed on or by the computer system. As used herein, the term “medium” refers to a single physical medium or a plurality of media that together store what is described as being stored on the medium. As used herein, the term “network device” can refer to any programmable device that is capable of communicating with another programmable device across any type of network. As used herein, the term “artificial intelligence” refers to a computer system configured to synthesize sets (e.g., robust or “big-data” sets) in way that simulates human ability to perceive, learn and infer in the course of performing problem-solving tasks or otherwise execute functions based on the data sets.

Persons of ordinary skill in the art are aware that software programs may be developed, encoded, and compiled in a variety of computing languages for a variety of software platforms and/or operating systems and subsequently loaded and executed by one or more processors (and/or other networked components) so as to enable the functions disclosed herein. The compiling of such software programs may transform program code written in a programming language to another computer language such that the processor(s) are able to execute the programming code. For example, the compiling process of the software program may generate an executable program that provides encoded instructions (e.g., machine code instructions) for the processor(s) to accomplish specific, non-generic, particular computing functions. After the compiling process, the encoded instructions may then be loaded as computer executable instructions or process steps to processor and/or embedded within the processor(s) (e.g., as a cache). The processor(s) can execute the stored instructions or process steps in order to perform instructions or process steps to transform the processor into a non-generic, particular, specially programmed machine or apparatus configured to function and/or carry out the processes described herein.

In one or more embodiments, artificial intelligence systems and methods for executing a function by an artificial intelligence that dynamically redefines a domain of a function to include dark data stored in a database are disclosed herein. The disclosed embodiments result in several advantages to the technical fields of computer science and artificial intelligence that are heretofore unrealized.

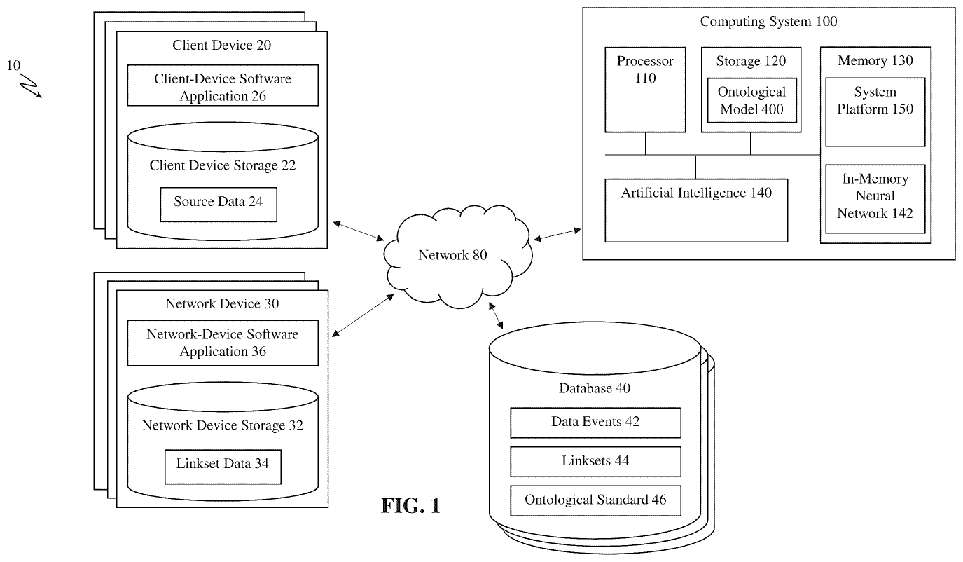

FIG. 1 schematically illustrates a system 10 in accordance with at least one embodiment.

The system includes a computing system 100, on which an artificial intelligence 140 is hosted. The computing system is connected to one or more networked devices, such as a network device 20, a client device 30, and a database 40, via a network 80.

The computing system 100 may be, for example, one or more servers or other computing devices. Further, the computing may be a distributed network system, such as a network cloud, across which the various components and functionality described within computing system 100 may be distributed. The computing system 100 may include, for example, a processor 110, a storage 120 and a memory 130. The processor 110 may include a single processor or multiple processors. Further, in one or more embodiments, the processor 110 may include different kinds of processors, such as a central processing unit (“CPU”) and a graphics processing unit (“GPU”).

The memory 130 may be operatively coupled to the processor 110, and may include a number of software or firmware modules executable by processor 110. The memory 130 may be a non-transitory medium configured to store various types of data, including but not limited to processor executable software programs for implementing the functions described herein, and may include a single memory device or multiple memory devices. For example, the memory 130 may include one or more memory devices that comprise a non-volatile storage device and/or volatile memory. Volatile memory, such as random-access memory (RAM), can be any suitable nonpermanent storage device. The non-volatile storage devices can include one or more disk drives, optical drives, solid-state drives (SSDs), tap drives, flash memory, read only memory (ROM), and/or any other type memory designed to maintain data for a duration time after a power loss or shut down operation. In certain instances, the non-volatile storage device may be used to store overflow data if allocated volatile memory is not large enough to hold all working data. The non-volatile storage device may also be used to store programs that are loaded into the volatile memory when such programs are selected for execution.

The storage 120 may include a non-transitory medium configured to store various types of data and information used in furtherance of executing the functions described herein. The stored data, e.g., data stored by a storage device, can be accessed by the processor 110 during the execution of computer executable instructions or process steps, in accordance with one or more processor executable software programs for implementing the functions described herein. Moreover, the storage 120 may be a single storage device, or multiple storage devices.

The computing system 100 may host the artificial intelligence 140, which may be a computer program configured to execute one or more functions via an in-memory neural network 142, in accordance with one or more system platforms 150, as described further herein. As used herein, the terms “function” or “functions,” when used in the context of functions executed, performed or carried out by the artificial intelligence 140, refers to operations performed by the artificial intelligence 140 with reference to data available to the artificial intelligence 140.

The computing system 100 may further comprise one or more system platforms 150, which may be process automation platform(s) that provide for automatically executing data analytics functions in accordance with the artificial intelligence 140, as described further herein. It will be understood that, while exemplary system platforms 150 are described herein with reference to certain industries, the principles of the invention are broadly applicable to any industry for which the automated evaluation of data-event scenarios, particularly with regards to big-data, is desired.

The client device 30 may include any kind of computing device accessible across network 80, with which computing system 100 may communicate data and information in furtherance of the functions described herein. For example, the client device 30 may be an additional computing system 100, a server, a remote computer, or the like, which may be controlled by the same or different entity as computing system 100 and/or any of the networked devices.

The client device 30 may include a client-device software application 26 configured to provide some or all of the functionality described herein, including but not limited to communicating data and instructions to and/or from the computing system 100. Further, the client-device software application 26 may provide an interface such that a user of client device 30 may utilize the various components and functionality of computing system 100. A user interface can include a display, positional input device (such as a mouse, touchpad, touchscreen, or the like), keyboard, or other forms of user input and output devices. When the output device is or includes a display, the display can be implemented in various ways, including by a liquid crystal display (LCD) or a cathode-ray tube (CRT) or light emitting diode (LED) display, such as an OLED display.

The client device 30 may further include a client-device storage 22 configured to store data and information used in furtherance of the functions described herein. The client-device storage 22 may be a non-transitory medium configured to store various types of data and information. For example, client-device storage 22 may include one or more memory devices that comprise a non-volatile storage device and/or volatile memory.

The client storage may store source data 24 therein. The source data 24 may be a record of data-events and corresponding values for one or more categories, as discussed herein. The data-event record may be generated and/or maintained by a client computer system. The source data 24 may be generated in accordance with industry, client or system standards that define categories and values that characterize the data events, as described herein. The source data 24 may be communicated to the computing system 100 in furtherance of the functions described herein.

The network device 20 may include any kind of computing device accessible across network 80, with which computing system 100 may communicate data and information in furtherance of the functions described herein. For example, the network device 20 may be an additional computing system 100, a server, a remote computer, or the like, which may be controlled by the same or different entity as computing system 100 and/or any of the networked devices.

The network device 20 may include a network-device software application 36 configured to provide some or all of the functionality described herein, including but not limited to communicating data and instructions to and/or from the computing system 100. Further, the network-device software application 36 may provide an interface such that a user of network device 20 may utilize the various components and functionality of computing system 100. A user interface can include a display, positional input device (such as a mouse, touchpad, touchscreen, or the like), keyboard, or other forms of user input and output devices. When the output device is or includes a display, the display can be implemented in various ways, including by a liquid crystal display (LCD) or a cathode-ray tube (CRT) or light emitting diode (LED) display, such as an OLED display.

The network device 20 may further include a network-device storage 32 configured to store data and information used in furtherance of the functions described herein. The network-device storage may be a non-transitory medium configured to store various types of data and information. For example, the network-device storage 32 may include one or more memory devices that comprise a nonvolatile storage device and/or volatile memory.

The network-device storage may store linkset data 34, including one or more linksets 44, as discussed herein. Each linkset 44 may associate one or more function(s) with corresponding domains that define the data available to the artificial intelligence 140 for executing the function(s) in accordance with the system platform 150. The linkset data 34 may be generated by subject matter experts in accordance with industry, client or system standards.

Accordingly, each domain may identify a set of relevant data-events available to the artificial intelligence 140 for executing the corresponding function. Each domain many also identify a set of relevant categories available to the artificial intelligence 140 for carrying out the corresponding function. Accordingly, the data available to the artificial intelligence 140 for carrying out the function may include values of the relevant data-events for the relevant categories.

In some embodiments, at least one linkset 44 associates a higher-order objective with a plurality of functions that the artificial intelligence 140 is configured to carry out in furtherance of that objective. As used herein, the term “objective” and “objectives,” when used in the context of objectives executed, performed or carried out by the artificial intelligence 140, refers to a higher-order function that involves the performance of the plurality of functions in order to carry out the objective. Such linksets 44 may therefore indirectly associate the objective with a corresponding domain defined by the functions associated with the objective. It will be understood that, while the principles are described herein with reference to the execution of functions, such principles are similarly applicable to the execution of objectives as higher-order functions.

The database 40 may be an organized collection of data stored in one or more non-transitory storage media accessible by the computing system 100. For example, database 40 may include one or more storage devices that comprise a non-volatile storage device and/or volatile memory, such as ROM, RAM, hard-drives, solid-state drives, removable drives, network storage, virtual memory, cache, registers, etc. The database 40 may further include database management software that permits management of the database 40 and the data stored therein, including creating, retrieving, updating, deleting and otherwise managing the stored data via the computing system 100 and/or other networked devices.

The database 40 may store linkset data 34, including one or more linksets 44 associated with the analytics functions executable by the artificial intelligence 140 (including big-data analytics functions) in accordance with the system platform 150, which linkset data 34 may be retrieved from the network devices.

The database 40 may also store an ontological standard 46. The ontological standard 46 may define industry, client and/or system standards for categories and values characterizing data-events.

The database 40 may also store one or more data-events 42 for use by the artificial intelligence 140 in executing the data analytics functions. The data-events may be retrieved from the client device(s), as described herein. Accordingly, the database 40 may store at least the data-events 42 constituting the respective domains of one or more functions to be executed by the artificial intelligence 140 in accordance with the system platform 150.

The database 40 may additionally store other data-events, which may include dark data-events 42′. As used herein, the term “dark data-events” and derivatives thereof refers to data-events that are stored in the database 40, but that, for a given function, are not associated with the domain of the function. In other words, dark data-events 42′ are data-events that the artificial intelligence 140 would not refer to in performing the function because the dark data-events 42′ do not fall within the domain for that function, as defined by the relevant linkset and the ontological standard.

The network 80 may include one or more different types of wired and/or wireless computer networks, such as the Internet, a corporate network, a Local Area Network (LAN), or a personal network, such as those over a Bluetooth connection. Each of these networks can contain wired or wireless programmable devices and operate using any number of network protocols (e.g., TCP/IP). The network 80 may be operatively connected to gateways and routers, servers, and end user computers, as known in the art, so as to enable the communication data and/or instructions over the network 80.

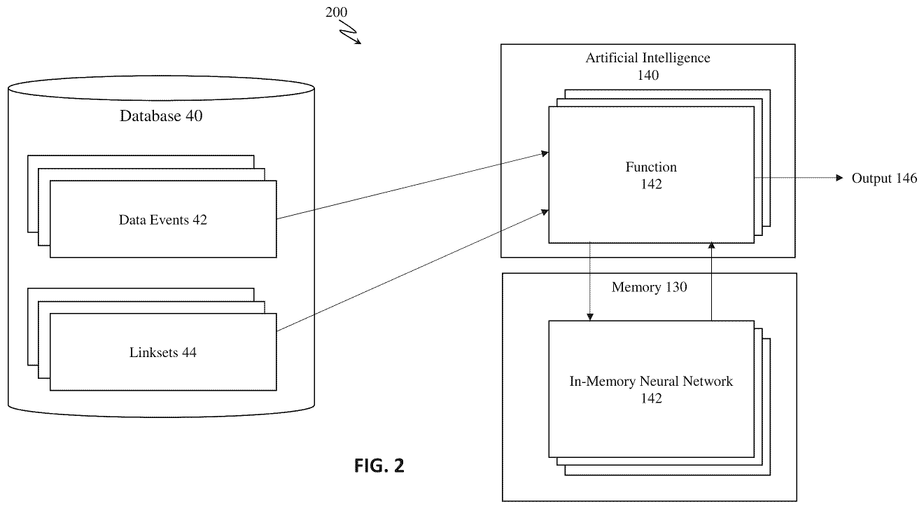

FIG. 2 illustrates a system architecture 200 according to one or more embodiments. The system architecture 200 comprises the artificial intelligence 140 operatively coupled to the database 40. The system architecture 200 may be implemented on the computing system 100 so as to carry out the functionalities and processes described herein. In particular, the system architecture 200 may be embodied by software stored in the memory 130 of the computing system 100, which when executed by the one or more processors 110 of the computing system 100, configures the computing system 100 with the functionality described herein.

The artificial intelligence 140 may be configured to execute one or more functions via the in-memory neural network 142. In operation, the artificial intelligence 140 executes the function by instantiating in the in-memory neural network 142 the data-events 42 that fall within the domain associated with the function, which domain is defined by the linkset 44 associated with the function, as described herein. The artificial intelligence 140 may be further configured to provide an output 210 as a result of executing the function.

The specific functions and outputs of the artificial intelligence 140 are only partially the subject of this application, as the principles described herein are generally applicable to various functions and outputs of those functions. However, specific types of functions can include, for example, a postulates status function that evaluates whether the data insufficiently evidences a defined postulate, conclusively evidences the postulate, or whether the data is inconclusive as to the postulate. Other examples include an impact computation function that evaluates the impact(s) of a defined scenario based on the data in the domain. Examples of such functions are described herein. Additional functions and outputs may be utilized without departing from the scope of the invention.

As discussed, the database 40 may store data-events 42 and/or linksets 44 that have been retrieved from the client device 30 and/or the network device 20. The data-events 42 and/or linksets 44 may be organized in the database 40 in accordance with known database management systems, techniques and/or methodologies. For example, the data-events 42 may be organized in one or more tables according to their corresponding values for one or more categories. It will be understood, however, that other database storage and management methodologies, including those that do not use tables, may be utilized without departing from the scope of the invention.

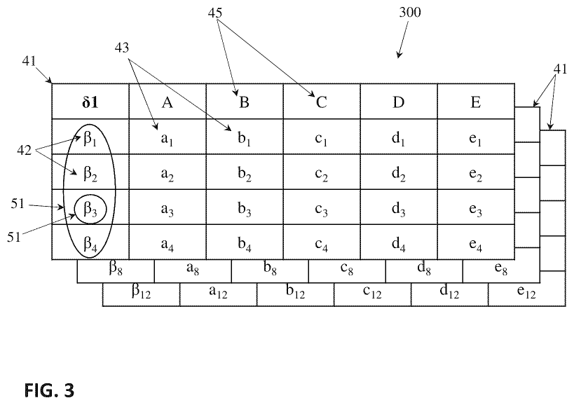

FIG. 3 schematically illustrates an exemplary table 300 for organizing data-events 42 stored in the database 40 according to their defining data-event values 43 for corresponding categories 45 (also referred to herein as attributes). It will be understood that, while the principles of the invention are described with reference to tables, the principles are generally applicable to non-table-based storage methods.

As shown for example in FIG. 3, the database 40 may store the data-events according to one or more data sets 41, with each data set comprising one or more data-events 42. The data-events 42 within each data set are likewise defined by corresponding data-event values 43 associated with one or more categories 45. In some embodiments, the database 40 may store a plurality of data sets, each of which may comprise of any number of data-events 42 associated with any number of categories 45. Moreover, as will become apparent from the discussions herein, the values, data sets and categories need not be unique.

In the illustrated example of FIG. 3, data set δ1 consists of the set of data-events {β1, β2, β3, β4}, each of which is defined by values for categories A-E. Accordingly, data-event β1 corresponds to values {a1, b1, c1, d1, e1} for categories A-E, respectively. The data-events β2, β3, β4 are similarly defined. Moreover, in the illustrated example of FIG. 3, categories A-E may be a subset of a larger set of possible categories defined by the ontological standard and/or the source data 24.

In addition, any given data-event 42 may correspond to one or more data-event scenarios 51. As used herein, a data-event “scenario” refers to a set of data-events whose categories and/or values satisfy one or more scenario defining rules. Such scenario defining rules may include, for example, that the data-events of the scenario share common categories and/or values. Thus, using the illustrated example of FIG. 3, one exemplary scenario might be defined as the set of data-events that have the common category A. Another scenario might be defined as the set of data-events that have the common value b3. In some embodiments, the scenario defining rules may include, for example, that the data-events of the scenario have categories and/or values that meet one or more thresholds. Thus, again referring to the illustrated example of FIG. 3, another scenario might be defined as the set of data-events 42 for which the value of a common category 45 is within a range of values. It will be understood by those of ordinary skill in the art that the scenario defining rules may be any rules that group data-events into sets according to their categories and/or values.

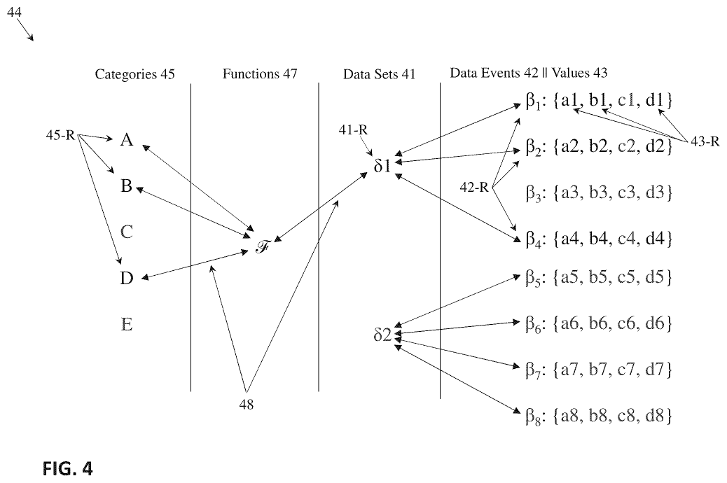

FIG. 4 schematically illustrates an exemplary linkset 44 in accordance with at least one embodiment. Each linkset 44 associates at least one function 47 with a corresponding domain, so as to define the data available to the artificial intelligence 140 for carrying out the function. In other words, the linksets 44 comprise a segmented data architecture with an array of interconnected index tables, where each indexed object has specifically associated vector values.

In particular, the linkset 44 associates the function with one or more relevant categories 45-R. The relevant categories 45-R represent the categories within which data-event values are available to the artificial intelligence 140 for carrying out the function with the domain defined by the linkset 44.

The linkset 44 also associates the function with one or more relevant data sets 41-R. Each relevant data set 41-R is, in turn, associated with one or more relevant data-events 42-R, which are the data-events 42 in the relevant data set 41-R that have values for the relevant categories 45-R. The relevant data-events 42-R represent the data-events whose values are available to the artificial intelligence 140 for carrying out the function with the domain defined by the linkset 44.

The linkset 44 further associates the function with one or more relevant values 43-R. The relevant values 43-R represent the values of the relevant data-events 42-R for the relevant categories 45-R. The relevant values 43-R represent the values that are available to the artificial intelligence 140 for caring out the function with the domain defined by the linkset 44.

In the illustrated example of FIG. 4, the linkset 44 comprises a set of links 48 that associate the function ƒ with the relevant categories A, B and D, and with data set δ1, thereby defining the domain of function ƒ The links 48 may be, for example, pointers or similar structures. Thus, as shown, the relevant categories would be A, B and D, and the relevant data-events would be: {β1, β2, β4}. Accordingly, in the illustrated example of FIG. 3 and FIG. 4, the data-event values 43 available to the artificial intelligence 140 for carrying out the function includes the relevant values: {a1, a2, a4, b1, b2, b4, d1, d2, d4}.

In operation, the artificial intelligence 140 executes the function by instantiating in the in-memory neural network 142 the data-events 42 that fall within the domain associated with the function. Thus, referring to the domain defined by exemplary linkset 44 of FIG. 4, in executing the function ƒ, the artificial intelligence 140 instantiates the relevant data-events {β1, β2, β4} in the in-memory neural network 142 and generates the result of the function ƒ executed using those instantiated data-events and their values for the relevant categories A, B and D.

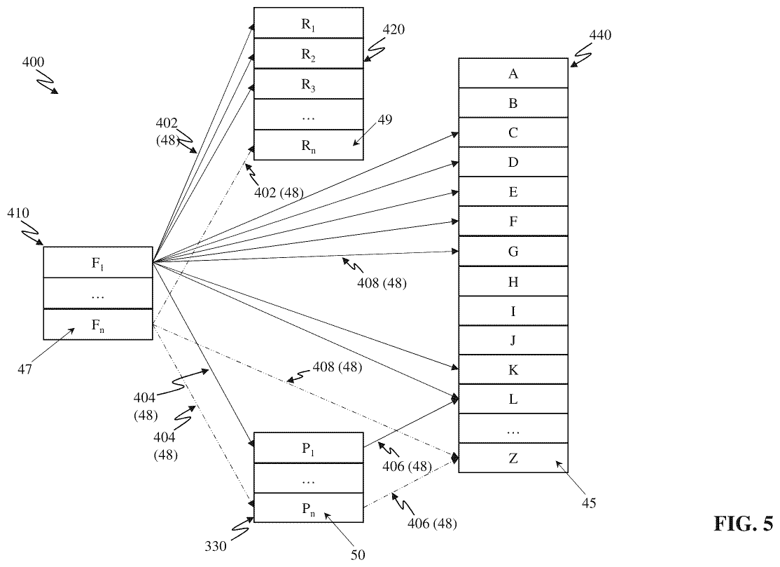

Turning now to FIG. 5, in at least one embodiment, the artificial intelligence 140 may be configured to utilize neutrosophic processing and/or apply an ontological model 400 to evaluate input source data 24 (e.g., data-events) in executing one or more functions and/or sub-functions thereof. The ontological model may comprise one or more linksets 44 in the storage 120. Accordingly, the ontological model may be generated from linkset data 34, in accordance with the ontological standard. It will be understood that while only one ontological standard is referenced for illustrative purposes, multiple ontological standards may be used without departing from the scope of the invention.

FIG. 5 illustrates an exemplary ontological model, comprising a function index table 410, a rules index table 420, a parameter index table 430 and a category index table 440.

The function index table 410 includes one or more index objects representing functions executable by the artificial intelligence 140. Specific types of functions can include, for example, a postulates status function that evaluates whether the data insufficiently evidences a defined postulate, conclusively evidences the postulate, or whether the data is inconclusive as to the postulate. Other examples include an impact computation function that evaluates the impact(s) of a defined scenario based on the data in the domain. Examples of such functions are described herein. Additional functions and outputs may be utilized without departing from the scope of the invention. The index objects representing the functions Fn are referred to herein, for simplicity, as simply functions Fn.

Each function may be linked, directly and/or indirectly, via specifically associated vector values, to one or more neutrosophic rules Rn of the rules index table 420, to one or more parameters Pn of the parameter index table 430, and/or to one or more categories A, B, C, etc. of the category index table 440.

The rules index table 420 includes one or more index objects representing neutrosophic rules Rn for executing linked functions Fn. For example, further to executing a function for identifying outlier scenarios, each Rn may represent a rule to evaluate one or more data-event attributes and/or scenarios for occurrence rates of common values with respect to one or more respective thresholds. The rule R1 may, for example, cause the evaluation of data-event attributes for occurrence rates of common values greater than or equal to 75%, whereas the rule R2 may cause the evaluation of data-event attributes for occurrence rates of common values between 25%-74%, and the rule R3 may cause the evaluation of data-event attributes for occurrence rates of common values less than 25%. The index objects representing the neutrosophic rules Rn are referred to herein, for simplicity, as the rules Rn.

Each rule Rn may be linked, via specifically associated vector values 402, to one or more functions Fn. Moreover, each function may be linked to the rule or rules Rn that are relevant to the execution of that function Fn.

The parameter index table 430 includes one or more index objects representing parameters Pn for defining, at least in part, the respective domains of the functions, particularly in terms of relevant data-event attributes, data-events and/or scenarios. For example, Pn may reflect parameters for defining the data-event scenarios 51 for which an outlier detection function is to detect outlier scenarios. The parameters Pn may generally include one or more value thresholds, ranges, rules or other boundary conditions, that data-events 42 must satisfy in order to be considered in the execution of the function. The index objects representing the parameters Pn are referred to herein, for simplicity, as the parameters Pn.

Each parameter Pn may be linked, via specifically associated vector values 404, to one or more functions Fn, as well as, via specifically associated vector values 406, to one or more categories A, B, C, etc. Moreover, each function Fn may be linked to the parameter or parameters Pn that are relevant to the execution of that function Fn. Similarly, each parameter Pn may be linked to the categories A, B, C, etc. that are relevant to determining the satisfaction of that parameter Pn.

The category index table 440 includes one or more index objects representing categories A, B, C, etc. via which data-events may be defined, in accordance with the ontological standard. The index objects representing the categories are referred to herein, for simplicity, as categories A, B, C, etc.

Each function Fn may be linked, via specifically associated vector values 408, to one or more categories. Moreover, each function Fn may be linked to the categories that are relevant to the execution of that function. Accordingly, each linkset 44 may reflect the ontological relationships between functions Fn, parameters Pn, and categories A, B, C, etc. contained in the ontological model.

In FIG. 5, an example linkset 44 for the ontological model is shown schematically as the solid arrows linking the specific index objects, while a generic linkset 44 is shown schematically as the dashed arrows linking the generic index boxes. It will further be understood that the ontological model shown in FIG. 5 is highly simplified for ease of illustrating the principles described herein. In actual operation, the ontological model may include (and is intended to include) an arbitrarily large number of functions, rules, parameters and categories.

In some embodiments, subject matter experts may establish and/or link the functions, rules, parameters, and/or categories via accessing the computing system 100 through the network-device software application 36. The linking may be so as to establish and/or maintain the relevancy of such linking within linksets 44. Accordingly, the network-device software application 36 provides for the ability to generate and/or otherwise maintain the ontological model, particularly with respect to changes to the ontological standard and/or subject matter expert understanding of the relationships between and among the functions, rules, parameters, and/or categories, as well as further functions, rules, parameters, and/or categories.

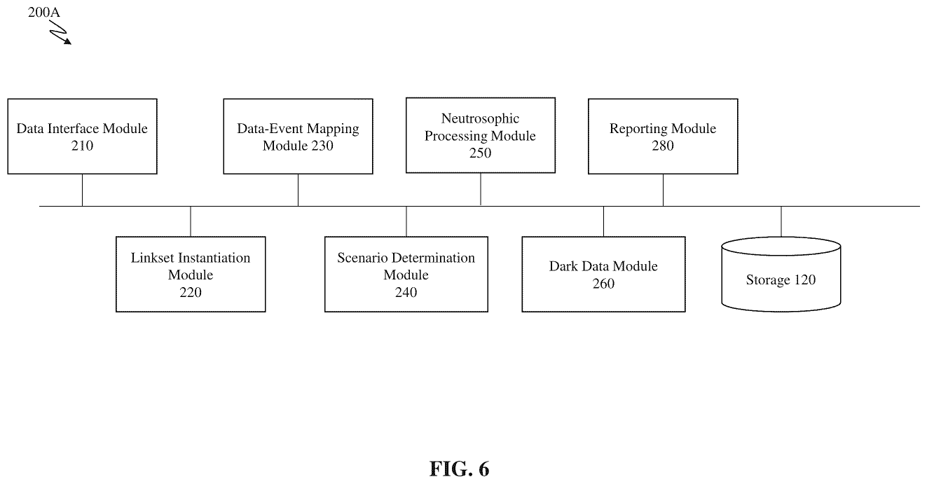

FIG. 6 illustrates an exemplary architecture 200A of the system platform 150 according to one or more embodiments. The platform architecture 200A comprises one or more software programs or functional modules that perform or otherwise cause the performance of one or more functions and/or aspects of the system platform 150, alone or in combination with other system components.

Moreover, as described herein, the system platform 150 utilizes the artificial intelligence 140 to carry out one or more functions and/or objectives, via the in-memory neural network 142, as described herein. Accordingly, one or more of the platform modules, or of the functionalities and/or aspects thereof, may be implemented via the in-memory neural network 142.

In some embodiments, the platform architecture 200A comprises one or more of: a data interface module 210, a linkset instantiation module 220, a data-event mapping module 230, a scenario determination module 240, a neutrosophic processing module 250, and a reporting module 280.

The data interface module 210 is configured to permit bi-directional communication of data and information between the platform architecture 200A and one or more external devices, such as the network device 20 and the client device 30.

Accordingly, the data interface module 210 may be configured to receive the linkset data 34 and the source data 24, as input from the network device 20 and the client device 30, respectively. The source data 24 and the linkset data 34 may be provided contemporaneously or non-contemporaneously with each other, and may further be respectively provided as a single input or as multiple inputs.

The data interface module 210 may be further configured to store the source data 24 and the linkset data 34 in the storage 120 for use by one or of the modules. The source data 24, in whole or in part, may be stored as the data-event table and/or updates thereto. The linkset data 34 may be stored, in whole or in part, as one or more linksets 44 of the ontological model and/or updates thereto. In some embodiments, the source data 24 and/or linkset data 34 may be used to generate the data-event table and/or the ontological model, as described herein.

An exemplary data-event table is shown in FIG. 3. As shown, the data-event table may comprise one or more data-events 42 characterized by values for one or more data-event categories. Each data-event 42 may further be associated with a unique identifier via the data-event table. For simplicity, the data-event 42 and its unique identifier are interchangeably referred to herein as the data-event 42.

Accordingly, each data-event 42 may be characterized by its corresponding combination of values. For example, the data-event β1 is characterized by the set of values {a1, b1, c1, d1, e1} for the categories A, B, C, D, and E, respectively. The categories and associated values may be recorded in the metadata of the data-event 42.

Moreover, set of data-events 42 having one or more common values may correspond to a data-event scenario, as discussed herein.

It will be understood that the data-event table shown in FIG. 3 is highly simplified for ease of illustrating the principles of the system described herein. In operation, the data-event table may be a “big-data” record of data-events 42, such that the data-event table may include several hundred-thousands of data-events 42, with several hundreds of attributes, each attribute having up to several thousands of possible values.

The data interface module 210 may additionally be configured to receive a user-intent input from the client device 30, which user-intent may identify one or more functions for execution by the system in furtherance of system platform objectives. In some embodiments, the user-intent may identify one or more objectives, which may be associated with one or more functions.

The user-intent may further identify one or more of the parameters Pn for at least partially defining the domains of one or more functions to be executed. Accordingly, the user-intent input via the data interface module 210 may define the scope and nature of the functions to be executed with respect to the input source data 24.

The linkset instantiation module 220 is configured to instantiate one or more linksets 44 of the ontological model in the in-memory neural network 142, based on the user-intent, the ontological model, and the source data 24/data-event table. Accordingly, the linkset instantiation module 220 may generate one or more tailored linksets for instantiation in the in-memory neural network 142.

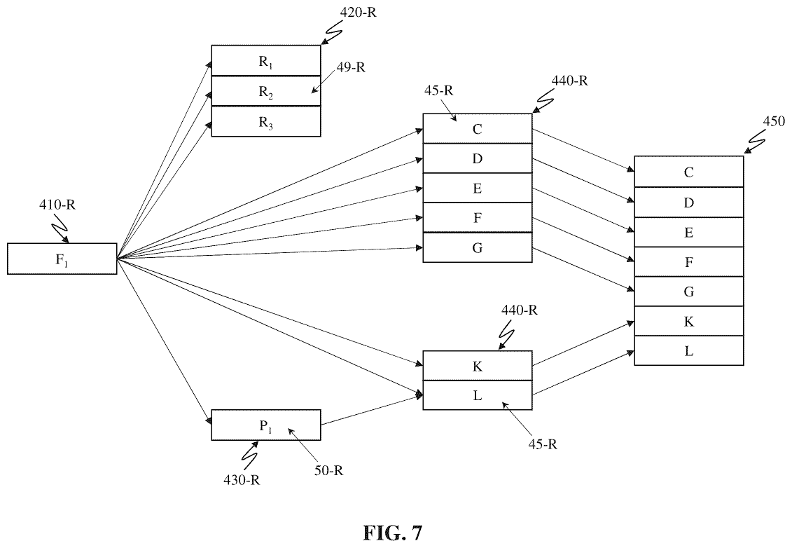

FIG. 7 schematically illustrates an exemplary tailored linkset 400-R for the function F1 and parameter P1. The tailored linkset 400-R preferably corresponds to the linkset 44 of the ontological model that is associated with the function F1 and parameter P1. Accordingly, the tailored linkset 400-R likewise comprises: a tailored function index table 410-R, a tailored rules index table 420-R, a tailored parameter index table 430-R and a tailored categories index table 440-R. As will be apparent to those of ordinary skill, each tailored index table reflects a subset of the corresponding index table of the ontological model.

The tailored linkset 400-R accordingly defines a summary class 450 comprising the categories of the tailored categories index table. The summary class 450 thus reflects a subset of categories with respect to which the source data 24 is to be analyzed via the function(s). In other words, the categories of the summary class 450 may be those categories identified by the ontological model as relevant to executing the linked function(s), i.e., the relevant categories 45-R as defined by the linkset 44.

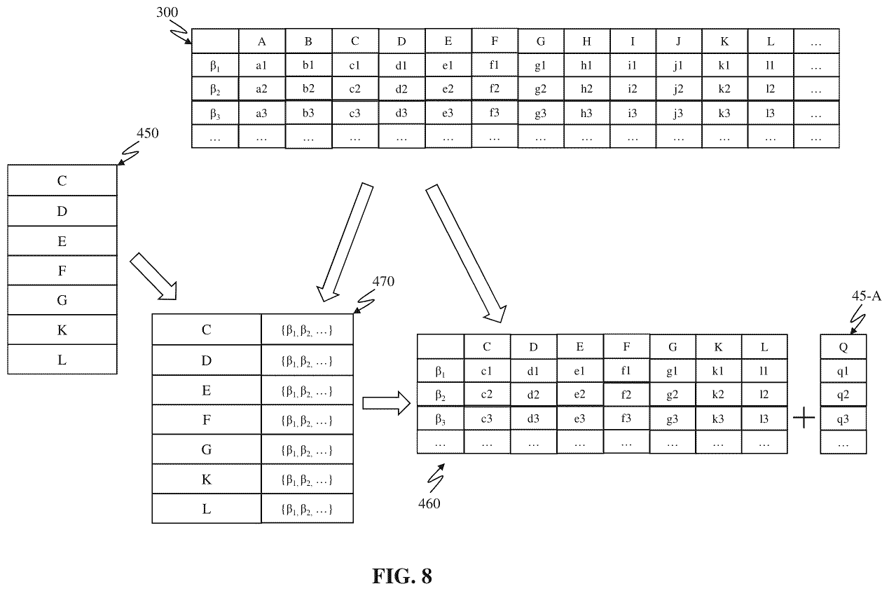

Turning now to FIG. 8, the data-event mapping module 230 is configured to map the source data 24 to the tailored linkset 400-R. Accordingly, the data-event mapping module 230 may generate an index class 460 via such mapping. The index class 460 may be instantiated in the in-memory neural network 142 by the linkset instantiation module 220. The index class 460 may associate a set of indexed data-events with the relevant categories 45-R of the summary class 450 via their respective values for those relevant categories 45-R. Accordingly, the index class 460 may comprise an index table, where each indexed object has specifically associated vector values associating the referenced indexed objects, although other methods of association are possible without departing from the scope of the invention.

In furtherance of generating the index class 460, the data-event mapping module 230 may generate an analysis class 470. Similar to the index class 460, the analysis class 470 may comprise an index table, where each indexed object has specifically associated vector values associating the referenced indexed objects, although other methods of association are possible without departing from the scope of the invention.

The analysis class 470 may associate the relevant categories 45-R (i.e., those categories of the summary class 450) with the data-events 42 of the source data 24 that have values for those relevant categories 45-R. The set of data-events that have values for the relevant categories 45-R is referred to herein as the set of indexed data-events, or the indexed data-events. The analysis class 470 identifies the set of indexed data-events, from the source data 24, to be considered by the artificial intelligence 140 in executing the function(s) of the platform.

An exemplary analysis class 470 is shown, for example, in FIG. 8. As shown, the analysis class 470 comprises the relevant categories 45-R (i.e., those categories of the summary class 450). Moreover, each of the relevant categories 45-R is associated, via the analysis class 470, with the indexed data-events (i.e., those data-events having values for the relevant categories 45-R). It will be understood that the analysis class 470 shown in FIG. 8 is highly simplified for ease of illustrating the principles of the system described herein. In actual operation, the analysis class 470 may be a “big-data” class, such that the analysis class 470 may include several hundred-thousands of relevant categories 45-R and indexed data-events.

The data-event mapping module 230 may generate the index class 460 from the analysis class 470. The index class 460 may associate, for each indexed data-event, the respective values for all the relevant categories 45-R in the analysis class 470. Accordingly, the data-mapping module may parse the values of the indexed data-events, so as to populate the index class 460.

An exemplary index class 460 is shown, for example, FIG. 8. As shown, the index class 460 comprises the values of each indexed data-event for each relevant category of the analysis class 470. In other words, the index class 460 may be thought of as linking or otherwise associating each indexed data-event to each relevant category of the analysis class 470 via the corresponding values of the indexed data-event for that relevant category.

In some embodiments, the data-event mapping module 230 may further supplement the index class 460 according to one or more additional categories 45-A, which may be derived or otherwise identified by the system platform 150 and/or the artificial intelligence 140, as described further herein. For example, the one or more additional categories 45-A may correspond to dark categories 45′ identified by the system platform 150. As another example, the one or more additional categories 45-A may correspond to parsed categories and/or values. Other additional categories 45-A may be derived and/or identified by the system platform 150 and/or the artificial intelligence 140 in furtherance of one or more objectives and/or functions. The data-event mapping module 230 may, in response to such identification, supplement the index class 460 by adding the additional categories 45-A. The data-event mapping module 230 may further populate the index class 460 so as to accordingly include corresponding indexed data-events and/or values.

The exemplary index class 460 of FIG. 8 is shown as supplemented with the additional category Z. Accordingly, the index class 460 includes the relevant categories 45-R and the additional categories 45-A, as well as corresponding values for each of the indexed data-events.

Accordingly, the index class 460 corresponds to the set of data-events 42 constituting a domain of input data that is instantiated in the in-memory neural network 142 and on which the artificial intelligence 140 utilizes neutrosophic processing to evaluate in executing the function(s) of the system platform 150.

As discussed herein, it may be useful for the system platform 150 to further limit the domain to data-events falling within one or more relevant scenarios 51-R, i.e., those scenarios defined by the linkset 44 as applicable to the execution of the function(s) and/or objective(s). Accordingly, the platform architecture 200A may include the scenario determination module 240 configured to identify one or more relevant scenarios 51-R from among the indexed data-events.

In some embodiments, the relevant scenarios 51-R may consist of those indexed data-events whose values satisfy one or more parameters of the linkset 44 (i.e., relevant parameters 50-R). Accordingly, the scenario determination module 240 may evaluate the values of the indexed data-events to determine whether the values satisfy the relevant parameters 50-R. For example, the relevant scenarios 51-R may be those data-events 42 whose values for a particular category exceed some predetermined or dynamically determined threshold, or otherwise match or do not match some target value. The scenario determination module 240 would, in that case, evaluate the indexed data-events against the corresponding relevant parameter 50-R to identify those data-events 42 comprising the relevant scenario(s).

The scenario determination module 240 may further generate a detail class 480 based on the evaluation. The detail class 480 may associate each of the data-events 42 in the relevant scenario(s) with their respective values for each category in the index class 460. In other words, the detail class 480 is effectively the index class 460, excluding the data-events 42 that do not fall within the relevant scenarios 51-R.

The detail class 480 thus corresponds to the set of data-events 42 constituting the domain of input data that may be instantiated in the in-memory neural network 142 and on which the artificial intelligence 140 may utilize neutrosophic processing to evaluate in executing the function(s) and/or objectives of the system platform 150. In other words, the detail class 480 contains the relevant data-events 42-R.

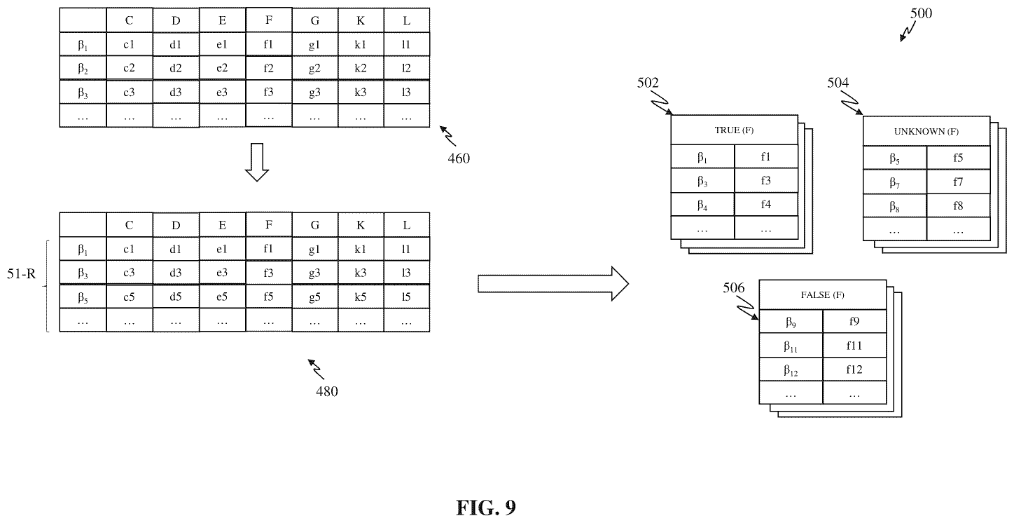

An exemplary detail class 480 is shown, for example, in FIG. 9. As shown, the detail class 480 identifies the relevant data-events 42-R (i.e., those within the relevant scenarios 51-R) and associates the relevant data-events 42-R with their respective values for each relevant category of the index class 460. Similar to the index class 460 and the analysis class 470, the detail class 480 may comprise an index table, where each indexed object has specifically associated vector values associating the referenced indexed objects, although other methods of association are possible without departing from the scope of the invention. Also similar to the index class 460 and the analysis class 470, the detail class 480 may be instantiated in the in-memory neural network 142.

The neutrosophic processing module 250 is configured to neutrosophically analyze/evaluate the relevant data-events 42-R according to the rules of the tailored linkset 400-R (i.e., relevant rules 49-R), so as to carry out the functions and/or objectives according to the tailored linkset 400-R. In particular, as described herein, the neutrosophic processing module 250 may apply the relevant rules 49-R to the relevant data-events 42-R on a per category basis and/or on a per scenario basis, so as to neutrosophically evaluate the data-events in furtherance of the functions and/or objectives.

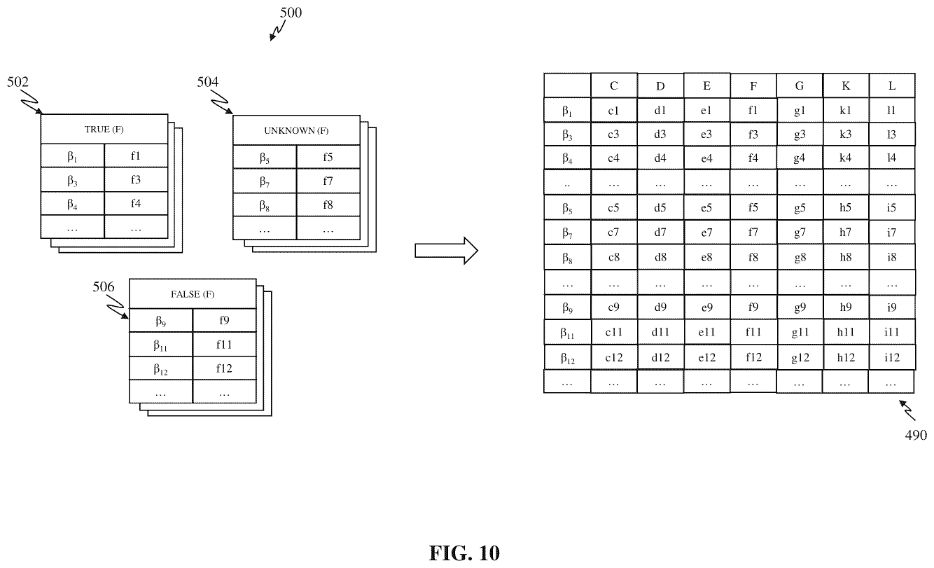

Accordingly, the neutrosophic processing module 250 may generate a computed class 490 from the relevant data-events 42-R. In particular, the neutrosophic processing module 250 may apply the relevant rules 49-R to the relevant data-events 42-R on a per category basis and/or on a per scenario basis, so as to determine membership in one or more truth categories 500. FIG. 10 illustrates exemplary truth categories 500 and an exemplary computed class 490.

The truth categories 500 may be defined by the relevant rules 49-R of the tailored linkset 400-R to neutrosophically evaluate the functions and/or objectives. Exemplary truth categories 500 are described herein with respect to illustrative examples of the inventive principles applied to various types of functions and/or objections. However, it will be understood that the truth categories 500 and associated rules are highly dependent on the nature of the function and/or objective to be executed.

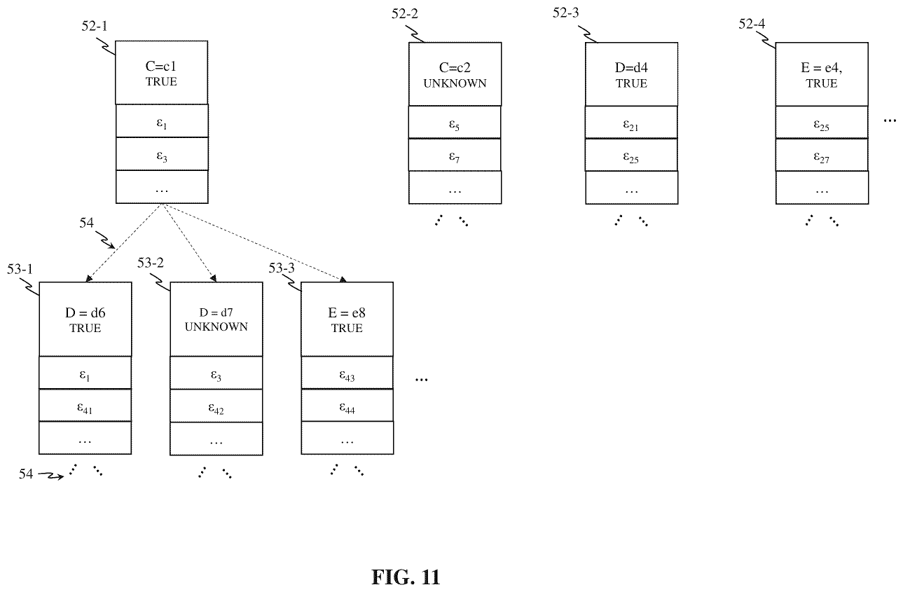

Turning now to FIG. 11, the neutrosophic processing module 250 may be further configured to utilize multi-level regression analysis techniques to neutrosophically analyze the relevant data-events 42-R of the computed class 490. Accordingly, the neutrosophic processing module 250 may identify and/or determine one or more first level data-event scenarios 52 one or more next level data-event scenarios 53. Each of the next level data-event scenarios 53 may be a sub-scenario of a particular first-level data-event scenario, thus establishing a unique scenario hierarchy 54 of data-event scenarios and sub-scenarios. Each sub-scenario may consider one or more other of the computed class categories not previously considered in the hierarchy. It will be understood that several such scenario hierarchies may be identified and/or determined, with each unique scenario hierarchy 54 branching out from one of the first level data-event scenarios 52.

In some embodiments, the neutrosophic processing module 250 is configured to analyze the plurality of unique multi-level data-event scenarios (i.e., scenario hierarchies), so as to identify one or more systemic occurrences of data-event scenarios and/or sub-scenarios. In other words, the neutrosophic processing module 250 may consider that some data-event scenario occurs, either independently or as a sub-scenario of higher-level data-event scenarios, at an occurrence rate that is statistically relevant for evaluating a relevant rule, or otherwise executing the functions and/or objectives of the system platform 150.

In some embodiments, the neutrosophic processing module 250 is configured to analyze the plurality of unique multi-level data-event scenarios (i.e., scenario hierarchies), so as to identify one or more significant comparisons between data-event scenarios and/or sub-scenarios. In other words, the neutrosophic processing module 250 may consider where some data-event scenarios or sub-scenarios are similar to others in a manner that is relevant for evaluating a relevant rule, or otherwise executing the functions and/or objectives of the system platform 150.

In addition, the neural architecture may contain suppression relationships between node values and outcome types. Suppression relationships are a form of computable context representation that minimize the potential number of false positives. Suppression drivers could be qualitative values, quantitative thresholds or rules that include both. In complex calculations and systemic scenarios multiple paths can lead to the same node value, and some paths may indicate that the node is relevant while others may compute that it is irrelevant. If a suppression driver reaches a predefined threshold, the node value is suppressed from the computation.

Such analysis may be executed in parallel for all multi-level data-event scenarios, or individually. Moreover, other multi-level data-event scenarios can reinforce the determinations made. The neutrosophic processing module 250 is thus configured to neutrosophically analyze the relevant data-events 42-R to evaluate relevant rules 49-R or otherwise execute the functions and/or objectives of the system platform 150.

Turning back to FIG. 6, the reporting module 280 is configured to generate one or more reports based on the neutrosophic processing. The reports may, at minimum, identify the result(s) of rule evaluations and/or the execution of the functions and/or objectives.

The reports may further be interactive reports, which include the ability for a user, via a GUI, to navigate the scenario hierarchies. The interactive reports may further identify data-event scenarios 51, and may additionally identify how many data-events 42 are contained within each data-event scenario identified. The reports also may identify additional evidence supporting the rule evaluation and/or function execution, such as identifying other multi-level data-event scenarios 51 that reinforce the evaluation and/or execution.

Returning now to FIG. 4, as discussed generally herein, the system platform 150 using the artificial intelligence 140 executes the function by instantiating in the in-memory neural network 142 the data-events 42 that fall within the domain associated with the function. Thus, referring to the domain defined by exemplary linkset 44 of FIG. 4, in executing function 9; the relevant data-events {β1, β2, β4} are instantiated in the in-memory neural network 142 and function ƒ is executed using those instantiated data-events 42 and their values for relevant categories A, B and D.

However, in relying solely on the linkset 44, data-events that fall outside of the domain of the function are not generally instantiated within the in-memory neural network 142. Such data-events will therefore not be considered in executing the function. Accordingly, in the example of FIG. 4, the data-events {β5, β6, β7, β8} would not be instantiated in the in-memory neural network 142 because the linkset 44 does not associate the function ƒ with the data set 62, and because the linkset 44 does not associate the function with ƒ with the categories C and D. Moreover, the data-event 33 would not be instantiated in the in-memory neural network 142 because the data-event 33 does not have values for the relevant categories A, B and D.

This gives rise to the phenomenon of dark data, which is data that is present in the database 40, but that is not used by the artificial intelligence 140 in executing the function ostensibly because the data is not within the linkset 44 defined domain of the function. Thus, the dark data is data that is “not seen” by the artificial intelligence 140 in executing the function. Such dark data can include dark categories 45′, dark data-events 42′, dark data-event values 43′, and dark data sets 41′, which will be discussed herein in more detail. In order for the artificial intelligence 140 to consider this dark data, the domain of the function must be redefined to include the dark data.

However, function domains have been heretofore predefined by subject matter experts (“SMEs”) based on the expert knowledge of the SME. In other words, turning to the example of FIG. 4, the SME that created the linkset 44 that defines the domain of function ƒ did so based on the SME's knowledge that data set δ1 was the relevant data set for function ƒ, and that categories A, B and D were the relevant categories for function ƒ It is therefore no simple matter for the SME to redefine the domain for the function to consider dark data, as doing so would require the SME to know what they do not know they do not know.

Accordingly, in some embodiments, the platform architecture 200A further comprises a dark data module 260 (FIG. 6). The dark data module 260 is configured to dynamically and automatically redefine the function domain, so as to include dark data that would otherwise not be considered by the artificial intelligence 140 in executing the associated function. In at least some embodiments, the domain is redefined in the course of executing the function(s) and/or objective(s).

More particularly, the dark data module 260 is configured to identify the dark data from the relevant data during execution of the function, and then redefine the domain to include the identified dark data via adjusting, varying or otherwise editing the linkset 44. In other words, the artificial intelligence 140 is provided with the domain for the function, and, in the process of executing the function according to that domain, dynamically redefines the domain (i.e., adjusts the linkset 44) to capture dark data that was not captured by the original domain definition of the linkset 44.

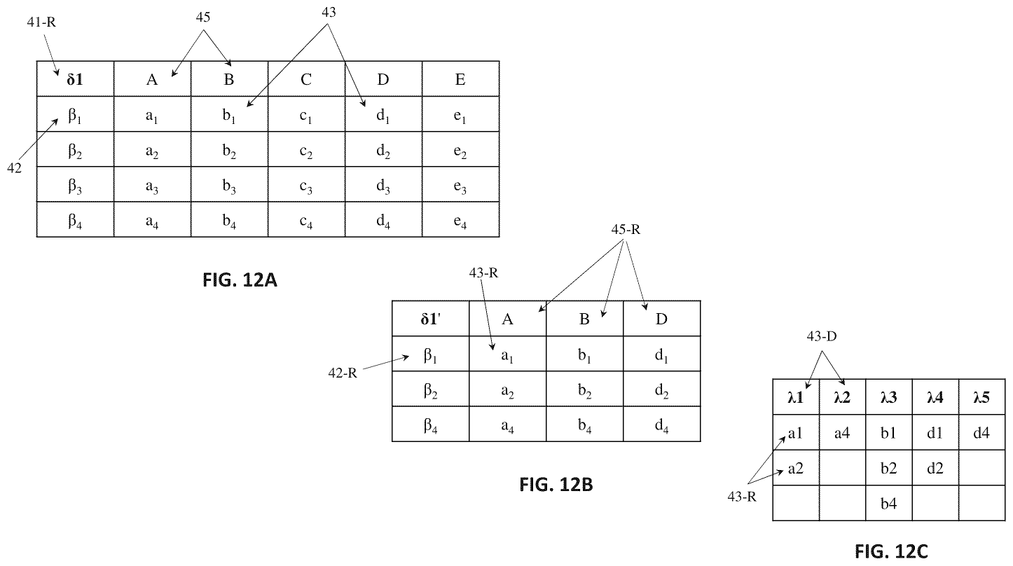

Accordingly, the dark data module 260 is configured to identify one or more discrete values 43-D from among the values of the relevant data-events 42-R constituting the detail class 480. FIGS. 12A-12C schematically represent such identification in accordance with at least one embodiment.

As discussed herein, the relevant data-events 42-R are those data-events of the relevant data set 41-R that have values for the relevant categories 45-R. For illustrative purposes, FIG. 12A schematically illustrates data set δ1 as the relevant data set. As will be appreciated, the relevant data set δ1 corresponds to the index class 460 discussed herein.

By contrast, the set of relevant data-events 42-R are schematically illustrated in FIG. 12B as set δ1′ containing relevant data-events {β1, β2, β4}. As will be appreciated, the set of relevant data-events δ1′ corresponds to the detail class 480 discussed herein. Accordingly, in the example, the set of relevant data-events does not include data-event β3, since data-event β3 is not a relevant data-event. In this case, data-event 33 would be a dark data-event, because it is not within the domain of the function defined by linkset 44.

In identifying the discrete values 43-D, the relevant values 43-R that correspond to the discrete values 43-D are identified and the discrete values 43-D are associated with the corresponding relevant values 43-R. In this context, values that “correspond” mean values that are logically equivalent albeit presented differently (e.g., in a different format).

The association can include generating a referential table or otherwise associating the discrete values 43-D to corresponding relevant values 43-R. For example, FIG. 12C schematically illustrates a referential table showing that discrete value λ1 is associated with relevant values {a1, a2}; discrete value λ2 is associated with relevant value {a4}; discrete value a3 is associated with relevant values {b1, b2, b4}; discrete value λ4 is associated with relevant values {d1, d2}; and discrete value a5 is associated with relevant value {d4}.

As used herein, the term “discrete value” refers to a value that is logically distinct from other values. For example, where the value of a category is a Boolean TRUE/FALSE, the distinct values would be TRUE and FALSE. In some embodiments, the distinct values also include their logical equivalents. So, for example, the distinct value of TRUE could also include simply T. As another example, the distinct numerical value of 5 can also include 5.0, V, five and other variations thereof. Similarly, distinct text values could include equivalent text values, such as abbreviations, acronyms, alternative spellings, misspellings, etc. Thus, discrete value λ1 is distinct from discrete value λ2, and so on.

The dark data module 260 is further configured to identify additional data-events that are outside the set of relevant data-events, but have values corresponding to the identified discrete values 43-D. In other words, the artificial intelligence 140 considers the data-events outside the index class 460 and/or detail class 480, and identifies those excluded data-events that have values which correspond to the identified discrete values 43-D. The other data-events may include data-events within the relevant data set 41-R and/or data-events in data sets other than the relevant data set 41-R.

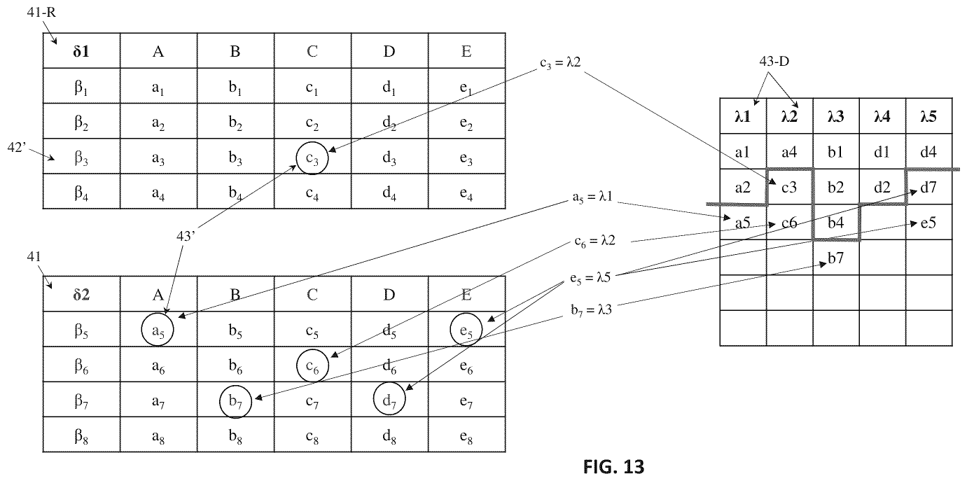

For example, FIG. 13 schematically illustrates the relevant data set δ1 where value c3 corresponds to previously identified discrete value λ2. Also illustrated is the other data set δ2 where value a5 corresponds to previously identified discrete value λ1; value b7 corresponds to previously identified discrete value λ3; value c6 corresponds to previously identified discrete value λ2; value d7 corresponds to previously identified discrete value λ5; and value e5 corresponds to previously identified discrete value λ5.

In identifying occurrences of the discrete values 43-D outside of the set of relevant data-events, the discrete values 43-D are associated with the corresponding values present in data-events other than the relevant data-events 42-R. This can include generating a referential table or otherwise associating the discrete values 43-D to corresponding values.

FIG. 13 also schematically illustrates a referential table showing that value c3 is associated with discrete value λ1; value a5 corresponds to previously identified discrete value λ1; value b7 corresponds to previously identified discrete value λ3; value c6 corresponds to previously identified discrete value λ2; value d7 corresponds to previously identified discrete value λ5; value e5 corresponds to previously identified discrete value λ5.

The associations are made based on identifying the occurrences of the discrete values 43-D outside of the set of relevant data-events. These other data-events where the discrete values 43-D occur are dark data-events 42′, and the values of the dark data-events 42′ are dark data-event values 43′.

Each discrete value is further associated with each category and/or data set in which the discrete value occurs, across all of the possible categories and/or data sets. This can include generating a referential table or otherwise associating the discrete values 43-D to corresponding categories and/or data sets where those discrete values 43-D occur.

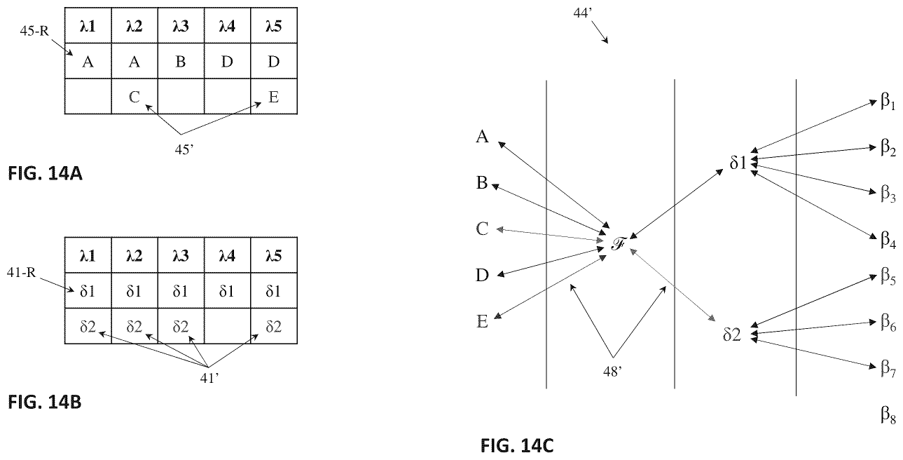

For example, FIG. 14A schematically illustrates a referential table that associates each discrete value with the category or categories where the discrete value occurs. Notably, the association includes categories other than the relevant categories 45-R. These other categories are dark categories 45′. As a further example, FIG. 14B schematically illustrates a referential table that associates each discrete value with the data set where the discrete value occurs. Notably, the association includes data sets other than the relevant data set 41-R. These other data sets are dark data sets 41′.

The dark data module 260 is further configured to adjust the linkset 44 so as to generate an adjusted linkset 44′ that maps each dark category and/or dark data set to the function, thereby redefining the domain for the function to include the dark data. In particular, the dark data-events 42′ are within the redefined domain for the function by virtue of being associated with data sets and categories that are now in the redefined domain, including the dark data sets 41′ and the dark categories 45′.

FIG. 14C schematically illustrates an example of the adjusted linkset 44′ showing additional links associating the function to the dark categories 45′ and to the dark data sets 41′. The dark data-events {33, 05, 06, 07} are shown to now be within the redefined domain of the function. Accordingly, the artificial intelligence 140 has dynamically redefined the domain of the function to include dark data.

In accordance with the aspects discussed herein, the dark data may now be instantiated in the in-memory neural network 142 according to the redefined domain, so as to execute the function using the dark data.

One or more of the foregoing aspects and principles may be applied in various contexts for the evaluation of applicable functions and/or objections. Specific exemplary applications are discussed herein, which are intended to illustrate the principles discussed herein and are not intended to be limiting.

In at least one embodiment, the system platform 150 may comprise a causality platform which may be a process automation platform for detecting causes of outlier data-event scenarios in one or more industries.

By way of additional context, it will be understood that, in the field of artificial intelligence, particularly with respect to identifying causes of outlier data-event scenarios, researchers typically must train artificial neural networks on hundreds to thousands of examples of a specific pattern or concept (i.e., specific scenarios) before the artificial synapse strengths adjust enough for the neural network to have “learned” that pattern or concept. However, such systems are not currently able to carry their experiences from one set of circumstances to another—i.e., to new scenarios—leading to the necessity of training new models for pattern recognizing new scenarios, even if those new scenarios are similar to those recognized via prior models. Such systems are indeed incapable of identifying new scenarios at all, without human intervention and substantial retraining.

Additionally, the increasing lag between the ability to generate data and to analyze it is further exasperated by the necessity of human retraining of the artificial intelligence models used in such analysis. Moreover, that retraining requires first that humans recognize the need for training new models. In other words, humans must first recognize that the current A.I. models are not recognizing a new pattern corresponding to a new scenario, before a new model can be trained to recognize it.

It is for at least the ability to identify new scenarios that may correspond to an existing model has evaded the field of artificial intelligence. Systems and methods that overcome these shortcomings are desirable, particularly in the fields where the analysis of data is required to identify potential causes of outlier scenarios.

An exemplary causality platform is discussed herein, which illustrates aspects of the present invention in the context of the health care payer industry. It will be understood that, while the health care industry is described herein as a specific use case, the principles of the invention are applicable to any industry for which the detection of potential causes of outlier data-event scenarios, particularly with regards to big-data, is desired.

In the context of the exemplary application, the client device 30 may, for example, be an enterprise-IT computer system of a health care industry payer, i.e., an organization that pays for administered medical services, such as a health insurance plan provider. The computer systems of a health care industry payer generally maintain records of payments made for medical services (i.e., the data-events 42)—which records include the attributes of such payments and/or the medical services (i.e., the data-event attributes). Those attributes are generally in accordance with the National Institute of Health (NIH), i.e., the Unified Medical Language System (UMLS), which defines the attributes and permissible values thereof for characterizing payments made for medical services (i.e., at least partially, the ontological standard).

Further in this context, the linkset data 34 may identify one or more potential causes (e.g., fraud, malpractice, etc.) of outlier data-event scenarios, and one or more parameters for defining the outlier data-event scenarios. The linkset data 34 may further identify, for each potential cause: one or more data-event attributes relevant to determining whether the potential cause is likely to cause outlier scenarios, and one or more rules for determining which of the potential causes are likely causes of the outlier scenarios.

In at least one embodiment, the causality platform may be configured to utilize neutrosophic processing, as discussed herein, to evaluate input source data 24 so as to detect causes of outlier data-event scenarios from the input source data 24. Such evaluation of the input source data 24 is referred to herein as automated causality detection.

In this context, the example index tables illustrated in FIG. 5 are tailored to detecting causes of outlier data-event scenarios. Accordingly, one or more functions of the function index table 410 may correspond to a respective potential cause (e.g., fraud, malpractice, etc.). Thus, for this illustrative application, the functions may be referred to as the corresponding potential causes.

In accordance with this exemplary application, the potential cause index table (i.e., the function index table, as tailored to the causality platform) includes one or more index objects representing potential causes of outlier data-event scenarios. For example, potential causes of outlier data-event scenarios in the health care payer industry may include: fraud, malpractice, coding error, payment policy error, incorrect diagnosis, incorrect procedure, incorrect drug, incorrect patient, incorrect charge, duplicate charge, duplicate claim, duplicated treatment protocols, etc. The index objects representing the potential causes are referred to herein, for simplicity, as simply the potential causes.

Each potential cause may be linked, via specifically associated vector values, to one or more neutrosophic rules of the rules index table 420, to one or more parameters of the parameter index table 430, and/or to one or more data-event attributes of the data-event attribute table (i.e., the category index table 440).

The rules index table 420 includes one or more index objects representing neutrosophic rules for truth determinacy with respect to linked potential causes. For example, each may represent a rule to evaluate one or more data-event attributes 45 and/or data-event scenarios 51 for occurrence rates of common values with respect to one or more respective thresholds. The rule R1 may, for example, cause the evaluation of data-event attributes for occurrence rates of common values greater than or equal to 75%, whereas the rule R2 may cause the evaluation of data-event attributes for occurrence rates of common values between 25%-74%, and the rule R3 may cause the evaluation of data-event attributes for occurrence rates of common values less than 25%. The index objects representing the neutrosophic rules are referred to herein, for simplicity, as the rules.

Each rule may be linked, via specifically associated vector values, to one or more potential cause. Moreover, each potential cause may be linked to the rule or rules that are relevant to the automated causality detection for that potential cause.

The parameter index table 430 includes one or more index objects representing parameters for defining outlier data-event scenarios with respect to linked potential causes. For example, the parameters may reflect parameters for defining the outlier data-event scenarios for which the causality platform is to detect causes for. The parameters may generally include one or more value thresholds, ranges, rules or other boundary conditions, that data-events 42 must satisfy in order to be considered an outlier data-event scenario. For example, parameter may require that outlier data-event scenarios have values for data-event attribute L (e.g., CHARGE_AMT) that exceeds some value threshold (e.g., $2,000). The index objects representing the parameters are referred to herein, for simplicity, as the parameters.

Each parameter may be linked, via specifically associated vector values, to one or more potential cause, as well as, via specifically associated vector values, to one or more data-event attributes. Moreover, each potential cause may be linked to the parameter or parameters that are relevant to the automated causality detection for that potential cause. Similarly, each parameter may be linked to the data-event attributes that are relevant to determining the satisfaction of that parameter.

The data-event attribute index table includes one or more index objects representing data-event attributes via which data-events 42 may be defined, in accordance with the ontological standard. For example, data-event attribute A may be EMP_PLAN_ID (i.e., employer plan identification); data-event attribute B may be PT_SX (i.e., practitioner class code); data-event attribute C may be PROV_NAME (i.e., provider name); data-event attribute D may be PROV_TYPE_CODE (i.e., provider type code); data-event attribute E may be PROV_SPECIALTY (i.e., provider specialty); data-event attribute F may be POS_DESC (i.e., procedure description); data-event attribute G may be DIAG_1 (i.e., diagnosis one); data-event attribute H may be DIAG_1_DESC (i.e., diagnosis one description); data-event attribute I may be PROC_CODE (i.e., procedure code); data-event attribute J may be PROC_DESC (i.e., procedure description); data-event attribute K may be DRG (i.e., medical procedure code); data-event attribute L may be CHARGE_AMT (i.e., charge amount). The index objects representing the data-event attributes are referred to herein, for simplicity, as the data-event attributes.

Each potential cause may be linked, via specifically associated vector values, to one or more data-event attributes. Moreover, each potential cause may be linked to the data-event attribute or attributes that are relevant to the automated causality detection for that potential cause. Accordingly, each linkset 44 may reflect the ontological relationships between potential causes, parameters, and data-event attributes contained in the ontological model.

Turning now to FIG. 6, in the context of this exemplary application, the data interface module 210 may be configured to receive user-intent input that identifies one or more of the potential causes for which the causality platform is to consider in the automated causality detection. In some embodiments, the user-intent may identify a clinical focus for the automated causality detection, which clinical focus may be associated with one or more of the potential causes, such that providing the clinical focus is tantamount to selecting one or more of the potential causes. For example, in the context of the health care industry, the clinical focus of: fee-for-service payments, may implicate the potential cause of: fraud.

The user-intent may further identify one or more of the parameters for defining the outlier data-event scenarios to be considered by the automated causality detection, with respect to each identified potential cause. For example, the user may only be interested in data-events where the value of data-event attribute L exceeds $2,000—i.e., data-events where CHARGE_AMT for the fee-for-service payments exceed $2,000.

Accordingly, the user-intent input via the data interface module 210 may define the scope and nature of the automated causality detection to be executed with respect to the input source data 24.

Turning now to FIG. 7, in the context of this exemplary application, the tailored linkset 400-R for the function F1 may correspond to a tailored linkset 400-R for the identified potential cause C1 and parameter P1. The tailored linkset 400-R preferably corresponds to the linkset 44 of the ontological model that is associated with the identified potential cause C1 and the parameter P1. Accordingly, the tailored linkset 400-R in the context of this exemplary application likewise comprises correspondingly tailored index tables.

For example, the tailored linkset 400-R may include the identified potential cause C1 (e.g., fraud) and the identified linked parameter P1 (e.g., CHARGE_AMT>$2,000), as well as the linked data-event attributes C (e.g., PROV_NAME), D (e.g., PROV_TYPE_CODE), E (e.g., PROV_SPECIALTY), F (e.g., POS_DESC), G (e.g., DIAG_1), K (e.g., DRG), and L (e.g., CHARGE_AMT) and the linked rules R1 (i.e., occurrence rate≥75%), R2 (i.e., 75%>occurrence rate≥25%), and R3 (e.g., occurrence rate<25%).

Moreover, in the context of this exemplary application, the summary class 450 (as shown in FIG. 8) reflects those data-event attributes identified by the ontological model as potential neutrosophically dependent variables with respect to the neutrosophically independent variable of the linked possible cause of outlier data-event scenarios.

For example, the data-event attribute F of POS_DESC is identified via the tailored linkset 400-R as potentially indicative, in a fuzzy logic sense, of the potential cause C1 of fraud for fee-for-service payments over $2,000 (as indicated by parameter P1).

As discussed herein, the analysis class 470 is generated that associates the data-event attributes of the summary class 450 with the data-events 42 of the source data 24 that have values for those summary class data-event attributes. Accordingly, the analysis class 470 identifies the set of indexed data-events, from the source data 24, to be considered via the automated causality detection.

In the context of this exemplary application, FIG. 8 shows the analysis class 470 as comprising data-event attributes C, D, E, F, G, K and L of the summary class 450. Moreover, each of the data-event attributes is associated, via the analysis class 470, with the indexed data-events.

Additionally, the index class 460 may associate, for each indexed data-event, the values for all the data-event attributes in the analysis class 470, as discussed herein. In the context of this exemplary application, FIG. 8 shows an exemplary index class 460 that comprises the values of each indexed data-event for each data-event attribute of the analysis class 470. In other words, the index class 460 may be thought of as linking each indexed data-event to each data-event attribute of the analysis class 470 via the corresponding values of the indexed data-event for that data-event attribute.

Moreover, as discussed herein, the index class 460 may be supplemented with one or more additional data-event attributes derived from parsed values of the indexed data-events. In particular, the data-event mapping module 230 may identify one or more values that repeat among the indexed data-events, and for which the index class 460 does not currently include the corresponding data-event attribute. For example, the value a1 for non-indexed attribute A may repeat among several indexed data-events—i.e., the values may be logically the same.

The data-event mapping module 230 may, in response to such identification, supplement the index class 460 by adding the data-event attribute corresponding to the repeating value. The data-event mapping module 230 may further populate the index class 460 so as to accordingly include, for each indexed data-event, the value corresponding to the added data-event attribute. The exemplary index class 460, as supplemented with the additional data-event attributes is shown, for example, in FIG. 8.

Turning now to FIG. 9, in the context of this exemplary application, the scenario determination module 240 may be configured to identify a set of outlier scenarios from among the indexed data-events-which outlier scenarios correspond to the relevant scenarios 51-R for consideration. In accordance with the discussions herein, the relevant scenarios 51-R are those indexed data-events whose values satisfy the parameters of the linkset 44. Accordingly, in the ongoing example, the outlier scenario defined by parameter P1 may all data-events for which the value of data-event attribute L (e.g., CHARGE_AMT) is in excess of $2,000. These data-events may be referred to herein as outlier data-events.

The scenario determination module 240 thereby generates the detail class 480 that associates, for each of the outlier data-events, the values for all the data-event attributes in the index class 460. An exemplary detail class 480 is shown, for example, in FIG. 9. As shown, the detail class 480 includes the values of each outlier data-event for each data-event attribute of the index class 460. The detail class 480 may be instantiated in the in-memory neural network 142.

The neutrosophic processing module 250 may neutrosophically analyze outlier data-event scenarios according to the rules of the tailored linkset 400-R, so as to determine whether the outlier data-event scenarios are likely caused by the potential causes defined by the tailored linkset 400-R.

Accordingly, the neutrosophic processing module 250 may generate the computed class 490 from the outlier data-events of the detail class 480. In particular, the neutrosophic processing module 250 may apply the rules to the outlier data-events, as described herein, so as to determine a truth category membership. The truth categories 500 may be defined by the respective rules to determine whether correlation is suggestive of causation, is indeterminate of causation, or is not suggestive of causation-in a neutrosophic analysis sense.

For example, the rule R1, as applied with respect to the data-event attributes, may cause the neutrosophic processing module 250 to evaluate the outlier data-events to identify those reoccurring values with occurrence rates greater than or equal to 75%. Those reoccurring values that satisfy the rule R1 may be assigned to a TRUE truth category, indicating that the rule has determined a level of correlation with the proposed cause (e.g., fraud) that is suggestive of causation.

Similarly, the rule R2, as applied with respect to the data-event attributes, may cause the neutrosophic processing module 250 to evaluate the outlier data-events to identify those reoccurring values with occurrence rates between 25%-74%. Those reoccurring values that satisfy the rule R2 may be assigned to an UNKNOWN truth category, indicating that the rule has determined a level of correlation with the proposed cause (e.g., fraud) that is indeterminate of causation.

Likewise, the rule R3, as applied with respect to the data-event attributes, may cause the neutrosophic processing module 250 to evaluate the outlier data-events to identify those reoccurring values with occurrence rates less than 25%. Those reoccurring values that satisfy the rule R3 may be assigned to a FALSE truth category, indicating that the rule has determined a level of correlation with the proposed cause (e.g., fraud) that is not suggestive of causation.

In the context of this exemplary application, FIG. 9 schematically illustrates exemplary truth categories 500 that associate, for each truth category, the reoccurring values that satisfies the corresponding rule with its corresponding data-event attribute 45 and outlier data-event.

For example, continuing with the previous example rules R1, R2, and R3 and data-event attribute F (i.e., POS_DESCR), the TRUE truth category indicates that the values f1 and f3 are the same value (e.g., PATIENT HOME) for at least 75% of the outlier data-events. Similarly, the UNKNOWN category indicates that the values f5 and f7 are the same value (e.g., EMERGENCY ROOM) for between 25%-74% of the outlier data-events. And, the FALSE category indicates that the values f9 and f11 are the same value, e.g. (URGENT CARE) for less than 25% of the outlier data-events.

While only one exemplary value is expressly described for each truth category, it is expressly contemplated that a plurality of values may qualify for each of the truth categories 500. Thus, the truth category for the associated data-event attribute 45 may include a first set of data-events having a first common value for the associated data-event attribute 45, as well as a second set of data-events having a second common value for the given data-event attribute 45. Moreover, while only the data-event attribute F (i.e., POS_DESCR) is shown, it is expressly contemplated that the truth category membership be determined for each of the summary class data-event attributes. In other words, truth category membership is also preferably determined for data-event attribute C, D, E, G, K and L.

The computed class 490 may thus be generated based on the determined truth category membership and the detail class 480, in accordance with the discussions herein. In particular, the computed class 490 may associate, for each of the outlier data-events identified from one or more of the truth categories 500 (e.g., the TRUE category and the UNKNOWN category), the values for all the data-event attributes 45 in the detail class 480. In other words, in the example, the computed class 490 is effectively the detail class 480, but excluding the outlier data-events that do not fall within the TRUE or UNKNOWN truth categories for at least one of the detail class data-event attributes.

Turning now to FIG. 10, in the context of this exemplary application, the computed class 490 includes all of the outlier data-events that, for at least one of the detail class data-event attributes, fall within either the TRUE or UNKNOWN truth categories. The computed class 490 therefore represents the data-event scenarios for which there is some level of correlation with the proposed cause (e.g., fraud) that is suggestive of causation.

Moreover, as discussed herein, the neutrosophic processing module 250 may be further utilize multi-level regression analysis techniques to further neutrosophically analyze the outlier data-event scenarios present in the computed class 490. Accordingly, as shown in FIG. 11, the neutrosophic processing module 250 may identify and/or determine one or more first level outlier data-event scenarios for each of the computed class data-event attributes.

As previously discussed, data-event scenarios 51 are defined by common values among the set of data-events 42 belonging to the data-event scenario. For example, the outlier data-event scenarios may be defined each as a set of common values, where each of the common values is for a different data-event attribute 45. Each outlier data-event scenario may therefore represent each combination and permutation of possible common values within the data-set of the computed class 490.

Moreover, the first level outlier data event-scenarios may correspond to outlier data-event scenarios where only one data-event attribute 45 is considered for the outlier data-event scenario. For example, as shown in FIG. 11, the first level outlier data-event scenario 52-1 represents the set of data-events 42 whose values for data-event attribute C are the common value c1. Further, the first level outlier data-event scenario 52-2 represents the set of data-events 42 whose values for data-event attribute C are the common value c2. Still further, the first level outlier data-event scenario 52-3 represents the set of data-events 42 whose values for data-event attribute D are the common value d3. And, the first level outlier data-event scenario 52-4 represents the set of data-events 42 whose values for data-event attribute E are the common value e4. The first level outlier data-event scenarios are preferably identified and/or determined for each common value of each data-event attribute 45.

In accordance with the regression analysis, the neutrosophic processing module 250 may further identify and/or determine one or more next level outlier data-event scenarios for each of the computed class data-event attributes. Each of the next level outlier data-event scenarios may be a sub-scenario of a particular first-level outlier data-event scenario, thus establishing a unique scenario hierarchy 54 of sorts, where each level of the hierarchy corresponds to another common value of another data-event attribute 45. Moreover, each sub-scenario considers one or more other of the computed class data-event attributes not previously considered in the hierarchy. It will be understood that several such scenario hierarchies may be identified and/or determined, with each unique scenario hierarchy 54 branching out from one of the first level outlier data-event scenarios.

For example, as shown in FIG. 11, the next level outlier data-event scenario 53-1 represents the set of data-events 42 whose values for data-event attribute C are the common value c1, and whose values for data-event attribute D are the common value d6. Further, the next level outlier data-event scenario 53-2 represents the set of data-events 42 whose values for data-event attribute C are the common value c1, and whose values for data-event attribute D are the common value d7. And, the next level outlier data-event scenario 53-3 represents the set of data-events 42 whose values for data-event attribute C are the common value c1, and whose values for data-event attribute E are the common value e8. The next level outlier data-event scenarios are preferably identified and/or determined for each common value of each other data-event attribute 45 of the computed class 490 that has not previously been considered in the particular scenario hierarchy 54.

The neutrosophic processing module 250 may continue to similarly identify and/or determine further next level outlier data-event scenarios, which may be further sub-scenarios considering further data-event attributes, such that each represented outlier data-event scenario and subs-scenario may be identified and/or determined. Thus, a plurality of unique multi-level outlier data-event scenarios may be identified and/or determined, which together represent all possible outlier data-event scenarios implicated by the computed class 490.

The neutrosophic processing module 250 may further be configured to analyze the plurality of unique multi-level outlier data-event scenarios, so as to identify one or more systemic occurrences of data-event scenarios, via consideration of the outlier data-event scenarios' truth category membership. In other words, the neutrosophic processing module 250 may consider that some data-event scenario occurs, either independently or as a sub-scenario of higher-level outlier data-event scenarios, at an occurrence rate that suggests causality with respect to the potential cause.

For example, the first level outlier data-event scenario may be a scenario where the outlier data-events (i.e., those data-events with CHARGE_AMT>$2,000) have a common value of PATIENT HOME for the data-event attribute of POS_DESC, and it may be identified that such common value occurs in over 25% (i.e., TRUE and UNKNOWN truth membership) of the outlier data-events. The next level outlier data-event scenario may further limit consideration to those outlier data-events that also have the common value of HEALTHSMART RX for the data-event attribute of PROV_NAME, and it may be identified that such common value occurs in over 75% (i.e., TRUE truth membership) of the outlier data-events that also meet the first-level outlier data-event scenario (i.e., also have POS_DESC as PATIENT HOME).

Accordingly, the multi-level data-event scenario indicates that, in the context of this exemplary application (i.e., the potential cause of fee-for-service insurance fraud), over 75% of charge amounts over $2,000 were made where the point-of-service was the patient's home—and that, of those, more than 75% were from the same provider. In other words, the multi-level data-event scenario is systemic in its occurrence.

The neutrosophic processing module 250 may be configured to determine, from discovering such systemic occurrences of multi-level data-event scenarios, whether such systemic multi-level data-event scenarios, on a case-by-case basis, are likely caused by the potential cause. In other words, the multi-level data-event scenarios are neutrosophically analyzed so as to determine which scenarios are neutrosophic independent variables causally associated with the neutrosophic dependent variables of the potential causes. Such analysis may be done in parallel for all multi-level data-event scenarios, or individually. Other multi-level data-event scenario can further reinforce the determination.

The system is accordingly configured to determine outlier scenarios that are likely caused by the potential cause, which causal connection would not be otherwise recognized by current artificial intelligences.

In addition, the reporting module 280 may be configured to generate a causality report, based on the outlier scenarios determined as likely caused by the potential cause. The causality report may, at minimum, identify the potential causes for which likely causality has been determined.

The causality report may further be an interactive report, which includes the ability for a user, via a GUI, to navigate the scenario hierarchies. The interactive report may further not only identify the outlier data-event scenarios determined as likely caused by the potential cause, but may also identify how many data-events (e.g., 1.36e+6) are contained within each outlier data-event scenario identified. The causality report also may identify additional evidence supporting the causal determination, such as identifying other multi-level data-event scenarios that reinforce the determination.

In at least one embodiment, the system platform 150 may comprise an auditing platform which may be a process automation platform for providing automated auditing services in one or more industries.

By way of additional context, auditing data and conclusions derived therefrom is a highly complex and time-consuming endeavor, made more so by the phenomenon that the incoming data is often provided from various sources and is therefore inconsistent. An exemplary industry in which such problems are present is the music royalty industry. The music industry is highly complex with multiple licenses and royalty owners. Each entity that is part of the industry is concerned about cost, timing and accuracy, which affects retaining/losing talent & customers, and maximizing income from leased or owned licenses. The increased consumption of music via Digital Service Providers (DSPs) has shifted the industry to more digitally focused royalty payments.

An exemplary auditing platform is discussed herein, which illustrates aspects of the present invention in the context of the music royalty industry. It will be understood that, while the music auditing industry is described herein as a specific use case, the principles of the invention are applicable to any industry for which auditing or otherwise analyzing data sets, particularly with regards big-data sets having inconsistent formats, is desired.

In the context of the exemplary application, the client devices may, for example, be computer systems of media exploiting entities (e.g., digital service providers, media sales entities, etc.) from which media exploitation data may be obtained by the computing system 100. In this context, “exploitation data” refers to data-event delineating media item exploitation events (e.g., plays, downloads, etc.). For example, the exploitation data for a given media item may delineate the circumstances (e.g., time, location, provider, etc.) of each download of the media item.

Further, in the context of the exemplary application, the network devices may, for example, be computer systems of rights holders and/or royalty rights data stores from which royalty rights data may obtained by the computing system 100. In this context, “royalty rights data” refers to linkset data 34 that defines relationships between media items and various rights holders with respect to the exploitation of those media items, which relationships are generally set forth in various contracts and/or agreements between the rights holders. For example, the royalty rights data for a given media item may indicate a per download royalty amount to be paid to an artist, in accordance with various contractual obligations. The royalty rights data may be used to define the ontological model, as discussed herein with respect to linkset data 34.

Accordingly, the computer systems of the music royalty industry generally maintain records of exploitation events (i.e., data-events 42) and royalty rights (i.e., linkset data 34)—which records include the attributes relevant to royalty rights determinations (i.e., data-event attributes 45), as well as links between relevant values/attributes, for characterizing royalty obligations. Those values/attributes may be generally in accordance with a global industry data model, which defines the attributes and standardized values thereof for characterizing royalty obligations.

In at least one embodiment, the auditing platform may be configured to utilize neutrosophic processing, as discussed herein, to evaluate input source data 24 so as to detect underreporting from the input source data 24. In some embodiments, an underreporting scenario may be thought of as a particular type of outlier data-event scenario determined according to an ontological model for detecting underreporting.

In this context, the example index tables illustrated in FIG. 5 are tailored to detecting underreporting according to the ontological model for detecting underreporting. Accordingly, one or more functions of the function index table 410 may correspond to functions for detecting underreporting.

The underreporting function(s) may be linked, via specifically associated vector values, to one or more neutrosophic rules of the rules index table 420, to one or more parameters of the parameter index table 430, and/or to one or more data-event attributes of the data-event attribute table (i.e., the category index table 440), as discussed herein.

In accordance with the discussions herein, the rules index table 420 includes one or more index objects representing neutrosophic rules for truth determinacy with respect to underreporting detection. For example, each may represent a rule for comparatively analyzing data-event values 43 and/or scenarios to determine underreporting. The rule R1 may, for example, cause the evaluation of data-event attributes 45 to determine whether the number of downloads for data-events 42 with common values is below 1.5 times the standard deviation from the mean number of downloads for data-events with other values. The rule R2 may, for example, cause the evaluation of data-event attributes 45 to determine whether the number of downloads for data-events 42 with common values is between 1 and 1.5 times the standard deviation from the mean number of downloads for data-events 42 with other values. The rule R3 may, for example, cause the evaluation of data-event attributes 45 to determine whether the number of downloads for data-events 42 with common values is within the standard deviation from the mean number of downloads for data-events 42 with other values.

Further in accordance with the discussions herein, the parameter index table 430 includes one or more index objects representing parameters for defining the scenarios for which the underreporting detection function(s) is to be executed. The parameters may generally include one or more value thresholds, ranges, rules or other boundary conditions, that data-events 42 must satisfy in order to be considered. For example, the parameters may indicate the particular media item and exploitation for which underreporting is to be detected—e.g., underreporting in the number of downloads for the song “Hotel California.” Other parameters may limit the underreporting detection to particular artists, media exploitation entities, or other entities; geographic regions; time spans; etc. Moreover, as discussed herein, the data interface module 210 may be configured to receive a user-intent input from the client device 30, which user-intent may identify one or more of the parameters for at least partially defining such scenarios as the domain against which the underreporting detection function is to be executed.

Still further in accordance with the discussions herein, the data-event attribute index table includes one or more index objects representing data-event attributes 45 via which data-events 42 may be defined, in accordance with the ontological standard. For example, the data-event attributes may include SONG (i.e., song name), ARTIST (i.e., artist name), EXPL_TYPE (i.e., the type of exploitation), SOURCE (i.e., the source of the exploitation data), and attributes reflecting characteristics of the source and/or the download. The underreporting functions may be linked, via specifically associated vector values, to one or more relevant data-event attributes.

Accordingly, each linkset 44 may reflect the ontological relationships between the underreporting function, parameters, and data-event attributes 45 contained in the ontological model.

Turning now to FIG. 6, in the context of this exemplary application, the data interface module 210 may be configured to receive user-intent input that identifies one or more of the scenarios for which the auditing platform is to consider in the automated underreporting detection.

In particular, the user-intent may identify one or more of the parameters for defining the scenarios to be considered. For example, the user may be interested in detecting underreported downloads of a particular song—i.e., where EXPL_TYPE is “download” and SONG is “Hotel California.” Accordingly, the user-intent input via the data interface module 210 may define the scope and nature of the automated underreporting detection to be executed with respect to the input source data 24.

Turning now to FIG. 7, in the context of this exemplary application, the tailored linkset 400-R for the function F1 may correspond to a tailored linkset 400-R for underreporting and parameters P1 and P2 (shown in dotted lines to distinguish from other examples discussed herein). The tailored linkset 400-R preferably corresponds to the linkset 44 of the ontological model that is associated with the underreporting function and the parameters P1 and P2. Accordingly, the tailored linkset 400-R in the context of this exemplary application likewise comprises correspondingly tailored index tables.

For example, the tailored linkset 400-R may include the underreporting function and the identified linked parameters P1 (e.g., SONG=“Hotel California”) and P2 (e.g., EXPL_TYPE=“download”), as well as the linked data-event attributes C (e.g., ARTIST), D (e.g., SOURCE), E (e.g., CHAR_E), F (e.g., CHAR_F), G (e.g., CHAR_G), K (e.g., EXPL_TYPE), and L (e.g., SONG) and the linked rules R1, R2, and R3.

Moreover, with reference to FIGS. 7-8, in accordance with the principles discussed herein, the index class 460 and/or detail class 480 may be generated in the context of this example, for neutrosophic processing. The neutrosophic processing module 250 may accordingly neutrosophically analyze the scenarios according to the rules of the tailored linkset 400-R, so as to determine whether the scenarios are likely indicative of underreporting, as defined by the tailored linkset 400-R.

Accordingly, the neutrosophic processing module 250 may generate and analyze the plurality of unique multi-level scenarios, so as to identify one or more significant comparisons between scenarios and/or sub-scenarios.

For example, the rule R1, as applied with respect to the data-event attributes 45, may cause the neutrosophic processing module 250 to evaluate data-event attributes 45 to determine whether the number of downloads for data-events 42 with common values is below 1.5 times the standard deviation from the mean number of downloads for data-events 42 with other values. Those common values that satisfy the rule R1 may be assigned to a TRUE truth category, indicating that the rule has determined a level of correlation indicating underreporting.

Similarly, the rule R2, as applied with respect to the data-event attributes 45, may cause the neutrosophic processing module 250 to evaluate whether the number of downloads for data-events 42 with common values is between 1 and 1.5 times the standard deviation from the mean number of downloads for data-events 42 with other values. Those common values that satisfy the rule R2 may be assigned to an UNKNOWN truth category, indicating that the rule has determined a level of correlation that is indeterminate of underreporting.

Likewise, the rule R3, as applied with respect to the data-event attributes 45, may cause the neutrosophic processing module 250 to evaluate whether the number of downloads for data-events 42 with common values is within the standard deviation from the mean number of downloads for data-events 42 with other values. Those common values that satisfy the rule R3 may be assigned to a FALSE truth category, indicating that the rule has determined a level of correlation that is not indicative of underreporting.

In the context of this exemplary application, FIG. 9 schematically illustrates exemplary truth categories 500 that associate, for each truth category, the reoccurring values that satisfies the corresponding rule with its corresponding data-event attribute 45 and data-event 42.

In the context of this exemplary application, the computed class 490 of FIG. 10 may thus be generated based on the determined truth category membership and the detail class 480, in accordance with the discussions herein. In particular, the computed class 490 may associate, for each of the outlier data-events identified from one or more of the truth categories 500 (e.g., the TRUE category and the UNKNOWN category), the values for all the data-event attributes in the detail class 480. In other words, in the example, the computed class 490 is effectively the detail class 480, but excluding the outlier data-events that do not fall within the TRUE or UNKNOWN truth categories for at least one of the detail class data-event attributes.

Moreover, as discussed herein, the neutrosophic processing module 250 may be further utilize multi-level regression analysis techniques to further neutrosophically analyze the data-event scenarios 51 present in the computed class 490. Accordingly, as shown in-principle in FIG. 11, the neutrosophic processing module 250 may identify and/or determine one or more first level data-event scenarios 52 for each of the computed class data-event attributes.

In this context, the first level data-event scenarios 52 may represent the set of data-events 42 whose values for data-event attribute D (i.e., SOURCE) represent the set of data-events 42 whose values for data-event attribute D (i.e., SOURCE) are the common value a1—indicating a common source for these data-events for which the number of downloads is below 1.5 times the standard deviation from the mean number of downloads for data-events with other values for data-event attribute D (i.e., other sources). Other first level data-event scenarios 52 may examine other attributes and values, in accordance with the principles discussed herein. Moreover, it will be understood that, while the first-level data-event scenarios of FIG. 11 show different attributes and values than discussed for this exemplary application, the principles are readily applied to the attributes and values discussed for this exemplary application.

In accordance with the regression analysis principles discussed herein, the neutrosophic processing module 250 may further identify and/or determine one or more next level data-event scenarios 53 for each of the computed class data-event attributes. Each of the next level data-event scenarios 53 may be a sub-scenario of a particular first-level data-event scenario, thus establishing a unique scenario hierarchy 54 of sorts, where each level of the hierarchy corresponds to another common value of another data-event attribute. Moreover, each sub-scenario considers one or more other of the computed class data-event attributes not previously considered in the hierarchy. It will be understood that several such scenario hierarchies may be identified and/or determined, with each unique scenario hierarchy 54 branching out from one of the first level outlier data-event scenarios.

The neutrosophic processing module 250 may continue to similarly identify and/or determine further next level data-event scenarios 53, which may be further sub-scenarios considering further data-event attributes, such that each represented data-event scenario and subs-scenario may be identified and/or determined. Thus, a plurality of unique multi-level data-event scenarios may be identified and/or determined, which together represent all possible data-event scenarios implicated by the computed class 490.

The neutrosophic processing module 250 may further be configured to analyze the plurality of unique multi-level data-event scenarios, so as to identify how (in this example) the number of downloads of a song varies across sources with respect to other source and/or exploitation characteristics. Such comparative analysis may identify potential underreporting scenarios where the number of downloads for a given scenario is a significant departure from the number of downloads for similar scenarios.

The potential underreporting scenario may accordingly be flagged for the attention of a user, in accordance with the principles discussed herein. As an example, the resulting data set may be made available via a user interface for viewing and a summary of the results may be displayed or otherwise provided.

In at least one embodiment, the system platform 150 may comprise a data-standardization platform which may be a process automation platform for standardizing data for evaluation by other system platforms 150 (e.g., the causality platform, etc.) with respect to one or more industries.

By way of additional context, the input data may not be standardized when it is received by the computing system 100 for evaluation by one or more of the system platforms 150. For example, industry data may be presented in myriad non-standardized formats due to numerous parties having unique formats for maintaining the data on their own systems. Moreover, the input data may be corrupted or otherwise incomplete when received. Such non-standard, corrupt and/or incomplete data is referred to herein as “bad data.” As a result of this “bad data,” data analytics becomes increasingly complicated and fraught with errors.

In at least one embodiment, the system platform 150 may be configured to utilize the artificial intelligence 140 and its neutrosophic processing, as discussed herein, to evaluate the input data so as to automatically detect and resolve occurrences “bad data.” Such automated detection and resolution of the input source data 24 is referred to herein as automated “bad data” resolution.

In particular, in the context of the previously discussed music royalty industry, input data related to the music industry for purposes of royalty audits may be provided as “bad data.” In this context, the exploitation data may be non-standardized exploitation data, such that the exploitation data may be organized according to one or more non-standardized data-event attributes and/or data-event values. For example, instead of the standardized data-event attribute SONG whose data-event value is “Hotel California,” in accordance with the ontological standard, the data-event 42 may be characterized by the data-event attribute TITLE whose data-event value is “hotel_california.” In this context, both the standardized and non-standardized data-events refer to the same song. However, the non-standardized data-event may be missed by the function(s) and/or objective(s) as “bad data” due to the attribute and/or value not complying with the ontological standard. Similarly, non-standardized royalty rights data may also be missed as “bad data.”

As discussed herein with respect to the principles discussed with reference to FIGS. 5 and 7, the ontological standard may define the standardized attributes and values for the ontological model.

In some embodiments, the transformation process may include referring to a set of updateable transformation rules correlating known non-standardized metadata fields with the standardized metadata fields.

The ontological model may also associate the standardized attributes and values with known logical equivalents via one or more rules and/or functions for such association. For example, the tailored linkset 400-R for the function F1 may correspond to a tailored linkset 400-R for resolving known “bad data” occurrences for the data-event attribute L. In this example, the data-event attribute L may be a known “bad data” attribute such as TITLE, as opposed to its logical equivalent standard data-event attribute SONG. Accordingly, the rule R1 may be to evaluate the data-event attributes of the input data to identify those data-events having the data-event attribute TITLE. The identification “bad data” in data-event values can be similarly accomplished.

Accordingly, in one or more embodiments, the automated “bad data” resolution may include automatically parsing and comparatively analyzing the metadata fields (i.e., data-event attributes) and entries (i.e., the values) of the data-events 42. The known “bad data” attributes and/or values can thus be detected from the parsed text of the data-event attribute and/or values.

Moreover, the ontological standard may be updated, via new or revised linkset data 34 correlating the known “bad data” attributes and/or values with the standardized data-event attributes and/or values. Such updating may be done by subject matter experts in response to recognizing previously unrecognized correlations.

However, where the “bad data” does not correspond to known “bad data” attributes and/or values, the neutrosophic processing and comparative analysis principles discussed herein may be applied to identify logical correspondence with standardized attributes/values. Indeed, one of ordinary skill in the art will appreciate that the same neutrosophic analysis principles discussed herein may be applied to comparatively analyze multi-level scenarios to determine logical correspondence between standardized attributes/values and “bad data” attributes/values.

In at least some embodiments, a high occurrence rate of common values for different data-event attributes may suggest that those data-event attributes logically correspond. For example, where “Hotel California” or its logical variants is the common value across for the different data-attributes: SONG, TITLE, and TRACK TITLE, such occurrence may suggest that SONG, TITLE and TRACK TITLE all logically correspond.

Moreover, in at least some embodiments, a strong correlation between highly occurring common multi-level scenarios, may suggest additional correspondence between data-event attributes. For example, where a highly occurring common multi-level scenario is SONG: “Hotel California,” ARTIST: “The Eagles,” ALBUM: “Greatest Hits,” TRACK: “Track 4,” the comparative analysis with the multi-level scenario of TRACK TITLE: “Hotel California,” ARTIST: “The Eagles,” ALBUM: “Greatest Hits,” TRACK: “Track 4,” may suggest that SONG and TRACK TITLE logically correspond.

Similarly, in at least some embodiments, a strong correlation between highly occurring common multi-level scenarios, may suggest additional correspondence between data-event attribute values. For example, where a highly occurring common multi-level scenario is SONG: “Hotel California,” ARTIST: “The Eagles,” ALBUM: “Greatest Hits,” TRACK: “Track 4,” the comparative analysis with the multi-level scenario of SONG: “hotel_california,” ARTIST: “The Eagles,” ALBUM: “Greatest Hits,” TRACK: “Track 4,” may suggest that “Hotel California” and “hotel_california” logically correspond.

It will be understood that, while the examples described herein refer to differently formatted data-event attributes/values, the same principles may be applied to resolving missing or corrupted data-event attributes/values. In other words, empty metadata fields and entries may be similarly resolved.

It will also be understood that while the examples described are limited for ease of illustrating principles, the parsing and comparative analysis is intended to be carried out on all or substantially all of the input data, across all or substantially all data-event attributes (or those relevant to the execution of the overall function(s)/objective(s)) and corresponding data-event values.

Additionally, as described herein, in one or more embodiments, the automated “bad data” resolution may include automatically parsing and comparatively analyzing the metadata fields (i.e., data-event attributes) and entries (i.e., the values) of the data-events. The known “bad data” attributes and/or values can thus be detected from the parsed text of the data-event attribute and/or values.

Moreover, the ontological standard may be updated, via new or revised linkset data 34 correlating the known “bad data” attributes and/or values with the standardized data-event attributes and/or values. Such updating may be done by subject matter experts in response to recognizing previously unrecognized correlations. Such updating may also be done automatically by the artificial intelligence 140.

In at least some embodiments, the updating of the data-event attributes and/or values involves creating new data files using the standardized data-event attributes and/or values according to the identified correlations. The updating may alternatively or additionally involve changing the metadata fields and/or entries to the corresponding standardized data-event attributes and/or values identified.

As will be appreciated by those of ordinary skill in the art, the standardized data may be utilized by the system platform 150 to execute one or more further data analytics functions and/or objections of the system platform 150. Accordingly, as the data is now standardized to the further functions/objections defined by the ontological model, the accuracy of such execution is improved.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

It is to be understood that the various components of the processes described above, could occur in a different order or even concurrently. It should also be understood that various embodiments of the inventions may include all or just some of the components described above. Thus, the processes are provided for better understanding of the embodiments, but the specific ordering of the components of the processes are not intended to be limiting unless otherwise described so.

It is to be understood that the above description is intended to be illustrative, and not restrictive. For example, the above-described embodiments may be used in combination with each other. As another example, the above-described processes include a series of actions which may not be performed in the particular order depicted in the drawings. Rather, the various actions may occur in a different order, or even simultaneously. Many other embodiments will be apparent to those of skill in the art upon reviewing the above description.

What is claimed is:

1. A artificial intelligence implemented method for executing a function by dynamically redefining a domain of the function to include dark data stored in a database, wherein the artificial intelligence instantiates data events in an in-memory neural network in accordance with the domain so as to execute the function, wherein the database includes a set of data events stored therein, wherein each data event is defined by a one or more values, wherein each value is associated with a category of a set of possible categories, wherein the function is mapped to a predefined set of relevant data events and a predefined set of relevant categories so as to initially define the domain of the function, wherein the set of relevant categories is a subset of the set of possible categories, wherein the set of relevant data events is a subset of the set of data events in which at least one data event has at least one relevant value, wherein a relevant value is a value associated with relevant category, the artificial intelligence implemented method comprising:
identifying one or more discrete values from among the relevant values of the relevant data events;
identifying, in other data events, values that correspond to the discrete values, wherein the other data events are within the set of data events but are not relevant data events;
linking each discrete value to each category of the set of possible categories in which the associated value for any data event corresponds to the discrete value, so as to identify one or more dark categories as categories that are linked to one or more of the discrete values and are not in the set of relevant categories;
mapping each dark category to the function, so as to redefine the domain;
instantiating in the in-memory neural network data events according to the redefined domain; and
executing the function in accordance with the redefined domain.

2. The method of claim 1, wherein each discrete value is logically distinct from each other discrete value, and where each discrete value corresponds to logically equivalent relevant values.

3. The method of claim 1, wherein identifying the discrete values includes:
associating each discrete value to corresponding relevant values via a first referential table.

4. The method of claim 1, wherein identifying, in other data events, values that correspond to the discrete values includes:
associating the discrete values to corresponding values of the other data events via a second referential table.

5. The method of claim 1, further comprising:
identifying dark-data events as the other data events having values that correspond to the discrete values; and
identifying dark-data event values as the values of the dark-data events.

6. The method of claim 1,
wherein the function includes detecting causes of outlier data-event scenarios, and
wherein the relevant data-events are data-events corresponding to predefined outlier data-event scenarios.

7. The method of claim 6, wherein executing the function in accordance with the redefined domain comprises:
applying one or more rules to the redefined domain so as to determine membership in a truth category;
generating a computed class based on the truth category membership, wherein the computed class associates, for each relevant data-event member of the truth category, the values of the data-event for each category of the computed class;
neutrosophically analyzing the computed class using multi-level regression analysis to identify (a) one or more first level outlier data-event scenarios for each category of the computed class, and (b) one or more next level outlier data-event scenarios for each category of the computed class, so as to determine a plurality of unique multi-level outlier data-event scenarios; and
neutrosophically analyzing the plurality of unique multi-level outlier data-event scenarios to identify one or more systemic occurrences of data-event scenarios that do not correspond to the predefined outlier data-event scenarios.

8. A artificial intelligence implemented method for determining royalty fees for media based on royalty fee implicating data comprising data-events obtained from a plurality of diverse digital service provider sources, the method comprising:
receiving, from each of the sources, data-events constituting data objects documenting instances of potentially royalty fee implicating events, wherein the data-events have data structures comprising a plurality of categories and associated data-event values characterizing the instances, and wherein the categories and/or data-event values are in inconsistent data formats as between at least some of the sources;
applying a normalization process to each music-related data structure, via a neural network configured to compare the categories and data-events, so as to generate a normalized music-related data structure, wherein the normalized music-related data structure comprising: a plurality of normalized categories and normalized data-event values, wherein the normalized categories and the normalized data-event values are in consistent data formats;
determining the royalty fees from the data-events based on the normalized categories and the normalized data-event values.

9. The method of claim 8, wherein the normalization process comprises a machine learning algorithm.

10. The method of claim 8, further comprising:
presenting at least part of the normalized data structure to the user for confirmation;
receiving, in response to the at least part of the normalized data structure, an indication that the normalized data structure is inaccurate, and
in response to the indication that the normalized data structure is inaccurate, modify the normalization process based on the indication of inaccuracy.

11. The method of claim 8, further comprising:
determining values for non-existent values in the data-events based on the normalized data structure and a global industry data model.

12. An artificial intelligence method for automatically identifying underpayments and/or underreporting of royalty fees with respect to media exploitation, comprising:
obtaining exploitation data files associated with a plurality of media items from a first plurality of data sources during a predetermined period of time, wherein the exploitation data files include exploitation data formatted according to metadata fields and corresponding field entries that are inconsistent for similar media items, wherein the exploitation data for each media item is a record of consumption of the media item;
applying a standardization schema to the exploitation data to generate standardized exploitation data files, wherein the standardized exploitation data files include the exploitation data formatted according to standardized metadata fields and corresponding standardized field entries that are consistent for the similar media items, wherein applying the standardization schema includes:
automatically parsing the metadata field entries and data entries;
simultaneously comparing multiple metadata fields and data entries across the exploitation files via an artificial intelligence module utilizing a neural architecture to determine previously non-existent relationships between node values within the neural architecture, wherein the node values correspond to the metadata fields and data entries;
determining, by the artificial intelligence, based on the determined relationships, and for each metadata field and data entry, a confidence value of correspondence with one of the standardized metadata fields and field entries;
resolving one or more of: missing data, corrupted data, misspelled data, and taxonomy diversity among the metadata fields and data entries, based on the confidence values;
obtaining royalty data from a second plurality of data sources, wherein the royalty data comprises royalty parameters characterizing royalty relationships between entities associated with the plurality of media items; and
determining an entity-specific royalty data for one or more of the entities based on a comparative analysis of the standardized exploitation data and the royalty data, wherein the entity-specific royalty data identifies underpayment and/or underreporting of royalty and/or licensee fees due to the one or more of: missing data, corrupted data, misspelled data, and taxonomy diversity among the metadata fields and data entries.

13. The method of claim 12, further comprising:
presenting the entity-specific royalty data in a user interface;
prompting a user to confirm the entity-specific royalty data; and
in response to receiving a confirmation, providing a digital certification for the entity-specific royalty data.

14. The method of claim 12, wherein the neural architecture comprises a plurality of potential simulations and a plurality of confirmed simulations, wherein the plurality of confirmed simulations have previously been confirmed by a user.

15. The method of claim 14, wherein the neural architecture further comprises suppression relationships between node values outcome type.

16. The method of claim 15, further comprising:
determining a subset of the standardized exploitation data that comprises outliers based on the entity-specific royalty data by identifying an unexpected behavior from the model from the application of the neural architecture to the royalty data;
obtain an indication of a modification to the neural architecture to address the unexpected behavior;
modifying the neural architecture based on indication of the modification; and
applying the modified neural architecture to the royalty data.

17. The method of claim 12, further comprising:
receiving an additional sample data set;
applying at least part of the neural architecture to obtain entity-specific royalty data for the additional sample data set, wherein the at least part of the neural architecture provides supplemental royalty information to the sample data set; and
providing sample entity-specific royalty data in the user interface.

18. The method of claim 12, further comprising:
receiving, through a preferred parameter module in a valuation user interface, preferred parameters for valuation, wherein the preferred parameter comprises one or more of an artist, an exploitation source, a record label, a particular media item, a consumption demographic, and a geographic region;
identifying a valuation data set from the standardized exploitation data; and
applying the neural architecture to obtain valuation data for the preferred parameters.
